(19) United States
(12) Patent Application Publication
(10) Pub. No.: US 2025/0347766 A1
(43) Pub. Date: Nov. 13, 2025

(54) COMMUNICATION DEVICE, INFORMATION PROCESSING METHOD, AND PROGRAM

(71) Applicants: KABUSHIKI KAISHA TOKAI RIKA DENKI SEISAKUSHO, Aichi (JP); NAGOYA INSTITUTE OF TECHNOLOGY, Aichi (JP)

(72) Inventors: Kento KATAOKA, Aichi (JP); Kenichi KOGA, Aichi (JP); Tatsuya KOIKE, Aichi (JP); Yoshiki OISHI, Aichi (JP); Nobuyoshi KIKUMA, Aichi (JP)

(73) Assignees: KABUSHIKI KAISHA TOKAI RIKA DENKI SEISAKUSHO, Aichi (JP); NAGOYA INSTITUTE OF TECHNOLOGY, Aichi (JP)

(21) Appl. No.: 18/992,388

(22) PCT Filed: Jun. 26, 2023
(86) PCT No.: PCT/JP2023/023661

§ 371 Date: Jan. 8, 2025

(30) Foreign Application Priority Data
Jul. 13, 2022 (JP) 2022-112337

(51) Int. Cl. G01S 5/04

(52) U.S. Cl. CPC G01S 5/04

(57) ABSTRACT

A communication device includes: a wireless communication unit configured to wirelessly receive signals from another communication device; and a control unit configured to correlate a first signal and a second signal, which is a signal corresponding to the first signal, received by the wireless communication unit at each specified time when the other communication device has transmitted a signal including a pulse as the first signal, convert a correlation calculation result that is a result of correlating the second signal and the first signal at each specified time into a format including a matrix product of a bin mode matrix that is a matrix including a plurality of elements indicating the correlation calculation result when it is assumed that a signal has been received at each of a plurality of set times and a plurality of set angles and an extended signal vector.

### TECHNICAL FIELD

The present invention relates to a communication device, an information processing method, and a program.

### BACKGROUND ART

In recent years, location identification technology in which one device identifies a location of another device in accordance with results of transmitting and receiving signals between devices has been developed. As an example of the location identification technology, the following Patent Literature 1 discloses technology in which an ultra-wide band (UWB) receiver identifies an input angle of a radio signal from a UWB transmitter by performing wireless communication in a UWB.

### CITATION LIST

### Patent Literature

Patent Literature 1: PCT International Publication No. WO2015/176776

### SUMMARY OF INVENTION

### Technical Problem

However, the input angle of the radio signal is identified in the technology described in the above-described Patent Literature 1, but there is still room for further improvement in terms of improving the accuracy of measurement of a distance and angle between a UWB receiver and a UWB transmitter.

That is, in the technology for measuring a distance between one device and another device, it is desirable to further improve the accuracy of measurement of the distance and angle between the devices.

Therefore, the present invention has been made in view of the above problems, and the objective of the present invention is to provide a mechanism capable of improving the accuracy of estimation of a distance and angle between two or more devices.

### Solution to Problem

In order to solve the above-described problem, one aspect of the present invention provides a communication device comprising: a wireless communication unit configured to wirelessly receive signals from another communication device; and a control unit configured to correlate a first signal and a second signal, which is a signal corresponding to the first signal, received by the wireless communication unit at each specified time when the other communication device has transmitted a signal including a pulse as the first signal, convert a correlation calculation result that is a result of correlating the second signal and the first signal at each specified time into a format including a matrix product of a bin mode matrix that is a matrix including a plurality of elements indicating the correlation calculation result when it is assumed that a signal has been received at each of a plurality of set times and a plurality of set angles and an extended signal vector that is a vector including a plurality of elements indicating presence or absence of a signal at each of the set time and the set angle and an amplitude and a phase of the signal, and estimate a reception time and an arrival angle of the second signal on the basis of the set times and the set angles corresponding to the plurality of elements in the extended signal vector, wherein an interval between the set times is shorter than the specified time.

In order to solve the above-described problem, another aspect of the present invention provides an information processing method comprising: wirelessly receiving signals from another communication device; correlating a first signal and a second signal, which is a signal corresponding to the first signal, received at each specified time when the other communication device has transmitted a signal including a pulse as the first signal; converting a correlation calculation result that is a result of correlating the second signal and the first signal at each specified time into a format including a matrix product of a bin mode matrix that is a matrix including a plurality of elements indicating the correlation calculation result when it is assumed that a signal has been received at each of a plurality of set times and a plurality of set angles and an extended signal vector that is a vector including a plurality of elements indicating presence or absence of a signal at each of the set time and the set angle and an amplitude and a phase of the signal; and estimating a reception time and an arrival angle of the second signal on the basis of the set times and the set angles corresponding to the plurality of elements in the extended signal vector, wherein an interval between the set times is shorter than the specified time.

In order to solve the above-described problem, another aspect of the present invention provides a program for causing a computer to function as: a control unit configured to correlate a first signal and a second signal, which is a signal corresponding to the first signal, received by a wireless communication unit wirelessly receiving signals from another communication device at each specified time when the other communication device has transmitted a signal including a pulse as the first signal; convert a correlation calculation result that is a result of correlating the second signal and the first signal at each specified time into a format including a matrix product of a bin mode matrix that is a matrix including a plurality of elements indicating the correlation calculation result when it is assumed that a signal has been received at each of a plurality of set times and a plurality of set angles and an extended signal vector that is a vector including a plurality of elements indicating presence or absence of a signal at each of the set time and the set angle and an amplitude and a phase of the signal; and estimate a reception time and an arrival angle of the second signal on the basis of the set times and the set angles corresponding to the plurality of elements in the extended signal vector, wherein an interval between the set times is shorter than the specified time.

### Advantageous Effects of Invention

As described above, according to the present invention, a mechanism capable of improving the accuracy of estimation of a distance and an angle between two or more devices is provided.

### BRIEF DESCRIPTION OF DRAWINGS

FIG. 1 is a diagram showing an example of a system configuration according to an embodiment of the present invention.

FIG. 2 is a diagram showing an example of an arrangement of a plurality of antennas provided in a vehicle according to the present embodiment. [FIG. 2] FIG. 3 is a diagram showing an example of location parameters of a portable device according to the present embodiment.

FIG. 4 is a diagram showing an example of location parameters of a portable device according to the present embodiment.

FIG. 5 is a diagram showing an example of a signal processing block in a communication unit according to the present embodiment.

FIG. 6 is a graph showing an example of a channel impulse response (CIR) according to the present embodiment.

FIG. 7 is a sequence diagram showing an example of a flow of a distance measurement process executed in the system according to the present embodiment.

FIG. 8 is a sequence diagram showing an example of a flow of an angle estimation process executed in the system according to the present embodiment.

FIG. 9 is an explanatory graph of the technical issues of the present embodiment.

FIG. 10 is an explanatory graph of the technical issues of the present embodiment.

FIG. 11 is an explanatory graph of the technical issues of the present embodiment.

FIG. 12 is an explanatory graph of the technical issues of the present embodiment.

FIG. 13 is an explanatory diagram for a case where multipath separation based on time information is difficult.

FIG. 14 is an explanatory diagram of multipath separation based on time information and angle information.

FIG. 15 is a diagram schematically showing differences between a delay profile, a bin mode matrix, and an estimated extended signal vector in a two-dimensional focal underdetermined system solver (2D-FOCUSS) and a focal underdetermined system solver (FOCUSS) according to the embodiment of the present invention.

FIG. 16 is a detailed explanatory diagram of a delay profile difference between the 2D-FOCUSS and the FOCUSS according to the present embodiment.

FIG. 17 is a detailed explanatory diagram of a bin mode matrix difference between the 2D-FOCUSS and the FOCUSS according to the present embodiment.

FIG. 18 is a detailed explanatory diagram of an extended signal vector difference between the 2D-FOCUSS and the FOCUSS according to the present embodiment.

FIG. 19 is an explanatory diagram of an example of a mode vector in the direction according to the present embodiment.

FIG. 20 is an explanatory diagram of an example of a mode vector in the direction according to the present embodiment.

FIG. 21 is an explanatory diagram of an example of a mode vector in the direction according to the present embodiment.

FIG. 22 is a flowchart showing an example of a flow of a location parameter estimation process executed by a communication unit 200 according to the present embodiment.

FIG. 23 is an explanatory diagram of an overview of beam space processing according to the present embodiment.

FIG. 24 is an explanatory diagram of multibeam formation according to the present embodiment.

FIG. 25 is an explanatory diagram of a matrix of signals after the multibeam formation according to the present embodiment.

FIG. 26 is an explanatory diagram of a method for performing selection based on an angle domain after selection based on a time domain according to the present embodiment.

FIG. 27 is an explanatory diagram of a method for performing selection based on the time domain after selection based on the angle domain according to the present embodiment.

FIG. 28 is an explanatory diagram of a method for simultaneously performing selection based on the time domain and selection based on the angle domain according to the present embodiment.

FIG. 29 is an explanatory diagram of a method for simultaneously performing selection based on the time domain and selection based on the angle domain according to the present embodiment.

### DESCRIPTION OF EMBODIMENTS

Hereinafter, referring to the appended drawings, preferred embodiments of the present invention will be described in detail. It should be noted that, in this specification and the drawings, structural elements that have substantially the same function and structure are denoted with the same reference signs, and repeated explanation thereof is omitted.

Moreover, in the present specification and in the drawings, elements having substantially the same functional configuration may be distinguished by adding a different letter after the same reference sign. For example, a plurality of elements having substantially the same functional configuration are distinguished as necessary like wireless communication units 210A, 210B, and 210C. However, when it is not necessary to particularly distinguish each of a plurality of elements having substantially the same functional configuration, only the same reference sign will be added. For example, when there is no need to particularly distinguish the wireless communication units 210A, 210B, and 210C, they are simply referred to as a wireless communication unit 210.

### 1. Example of Configuration

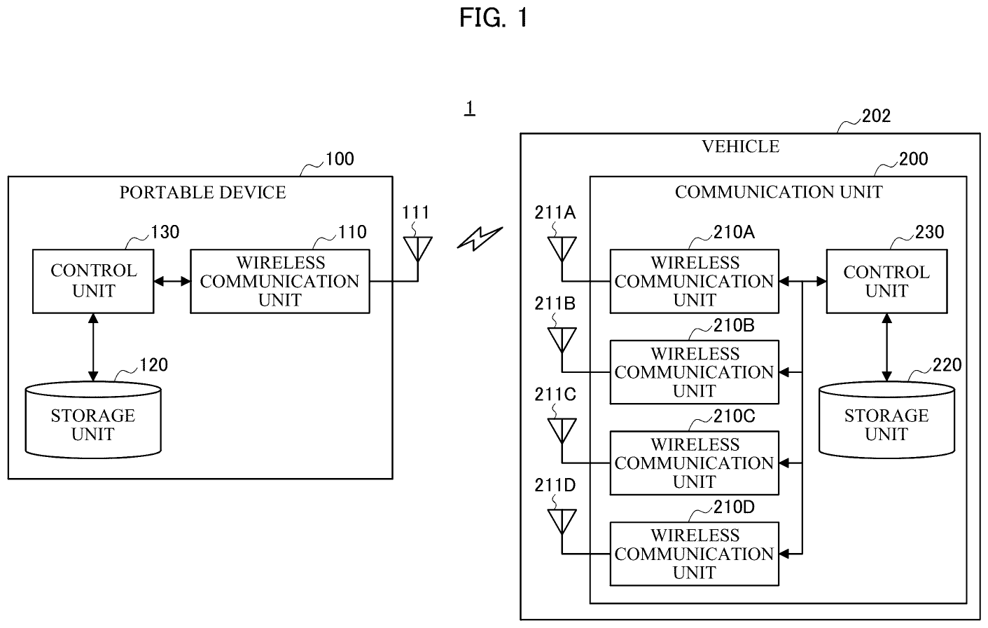

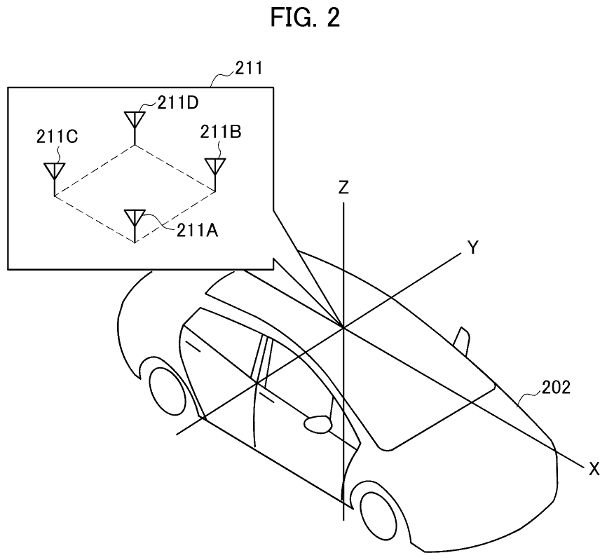

FIG. 1 is a diagram showing an example of a configuration of a system 1 according to an embodiment of the present invention. As shown in FIG. 1, the system 1 according to the present embodiment includes a portable device 100 and a communication unit 200. The communication unit 200 in the present embodiment is mounted on a vehicle 202. The vehicle 202 is an example of a user usage target.

The present invention involves a communication device on an authenticated party side and a communication device on an authenticating party side. In the example shown in FIG. 1, the portable device 100 is an example of the communication device on the authenticated party side and the communication unit 200 is an example of the communication device on the authenticating party side.

In the system 1, when a user (e.g., a driver of the vehicle 202) approaches the vehicle 202 with the portable device 100, wireless communication for authentication is performed between the portable device 100 and the communication unit 200 mounted on the vehicle 202. Also, if authentication is successful, a door lock of the vehicle 202 is unlocked or an engine is started and the vehicle 202 is made available to the user. The system 1 is also referred to as a smart entry system. Hereinafter, constituent elements will be sequentially described.

### (1) Portable Device 100

The portable device 100 is configured as any device carried by the user. Any devices include electronic keys, smartphones, wearable terminals, and the like. As shown in FIG. 1, the portable device 100 includes a wireless communication unit 110, a storage unit 120, and a control unit 130.

The wireless communication unit 110 has a function of performing wireless communication with the communication unit 200 mounted on the vehicle 202. The wireless communication unit 110 receives a radio signal from the communication unit 200 mounted on the vehicle 202 and transmits the radio signal.

Wireless communication between the wireless communication unit 110 and the communication unit 200 is implemented by, for example, a signal using an ultra-wide band (UWB). If an impulse scheme is used in wireless communication of the signal using the UWB, a propagation delay time of radio waves can be measured with high accuracy by using radio waves having a very short pulse width of nanoseconds or less and distance measurement based on the propagation delay time can be performed with high accuracy. The propagation delay time is a period of time required until radio waves are transmitted and received. The wireless communication unit 110 is configured as a communication interface capable of, for example, UWB communication.

In addition, the signal using UWB can be transmitted and received as, for example, a distance measurement signal, an angle estimation signal, and a data signal. The distance measurement signal is a signal to be transmitted and received in a distance measurement process to be described below. The distance measurement signal may be configured in a frame format without having a payload portion that stores data or may be configured in a frame format having a payload portion. The angle estimation signal is a signal to be transmitted and received in an angle estimation process to be described below. A configuration of the angle estimation signal may be similar to that of the distance measurement signal. The data signal is preferably configured in a frame format having a payload portion that stores data.

Here, the wireless communication unit 110 has at least one antenna 111. Also, the wireless communication unit 110 transmits and receives a radio signal via at least one antenna 111.

The storage unit 120 has a function of storing various types of information for an operation of the portable device 100. For example, the storage unit 120 stores a program for the operation of the portable device 100, an identifier (ID) for authentication, a password, an authentication algorithm, and the like. The storage unit 120 includes, for example, a storage medium such as a flash memory and a processing device that performs recording and reproduction on the storage medium. The control unit 130 has a function of executing a process in the portable device 100. As an example, the control unit 130 controls the wireless communication unit 110 and communicates with the communication unit 200 of the vehicle 202. The control unit 130 reads information from the storage unit 120 and writes information to the storage unit 120. The control unit 130 also functions as an authentication control unit that controls an authentication process to be performed with the communication unit 200 of the vehicle 202. The control unit 130 includes, for example, electronic circuits such as a central processing unit (CPU) and a microprocessor.

### (2) Communication Unit 200

The communication unit 200 is provided in association with the vehicle 202. Here, it is assumed that the communication unit 200 is mounted on the vehicle 202, such as being installed in the cabin of the vehicle 202 or incorporated into the vehicle 202 as a communication module. In addition, the vehicle 202 and the communication unit 200 may be configured as separate bodies in a case where the communication unit 200 is provided in a parking lot of the vehicle 202 and the like. In this case, the communication unit 200 may wirelessly transmit a control signal to the vehicle 202 on the basis of a result of communication with the portable device 100 and remotely control the vehicle 202. As shown in FIG. 1, the communication unit 200 includes a plurality of wireless communication units 210 (210A to 210D), a storage unit 220, and a control unit 230.

The wireless communication unit 210 has a function of performing wireless communication with the wireless communication unit 110 of the portable device 100. The wireless communication unit 210 receives a radio signal from the portable device 100 and transmits the radio signal to the portable device 100. The wireless communication unit 210 is configured as a communication interface capable of, for example, UWB communication.

Here, each wireless communication unit 210 has an antenna 211. Also, each wireless communication unit 210 transmits/receives a radio signal via the antenna 211.

The storage unit 220 has a function of storing various types of information for the operation of the communication unit 200. For example, the storage unit 220 stores a program for the operation of the communication unit 200, an authentication algorithm, and the like. The storage unit 220 includes, for example, a storage medium such as a flash memory and a processing device that performs recording and reproduction on the storage medium.

The control unit 230 has a function of controlling the overall operations of the communication unit 200 and the in-vehicle device mounted on the vehicle 202. As an example, the control unit 230 controls the wireless communication unit 210 and communicates with the portable device 100. The control unit 230 reads information from the storage unit 220 and writes information to the storage unit 220. The control unit 230 also functions as an authentication control unit that controls the authentication process to be performed with the portable device 100. Moreover, the control unit 230 also functions as a door lock control unit that controls the door lock of the vehicle 202, and locks and unlocks the door lock. Moreover, the control unit 230 also functions as an engine control unit that controls the engine of the vehicle 202 and starts/stops the engine. In addition, a power source provided in the vehicle 202 may be a motor or the like in addition to the engine. The control unit 230 is configured as, for example, an electronic circuit such as an electronic control unit (ECU).

### 2. Technical Features

### 2.1. Location Parameters

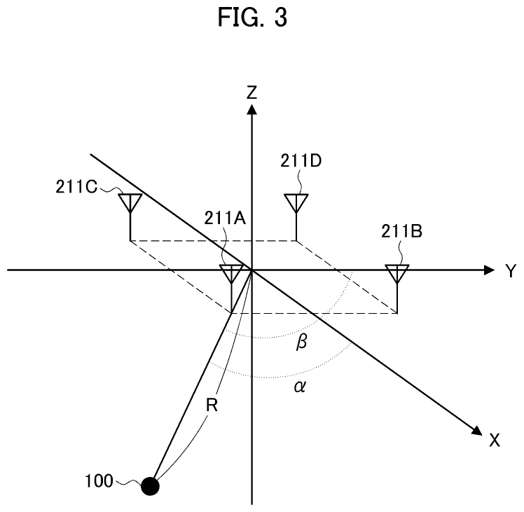

The communication unit 200 according to the present embodiment (specifically, the control unit 230) performs a location parameter estimation process of estimating a location parameter indicating a location where the portable device 100 is located. Hereinafter, various types of definitions related to location parameters will be described with reference to FIGS. 2 to 4.

FIG. 2 is a diagram showing an example of an arrangement of a plurality of antennas 211 (wireless communication units 210) provided in the vehicle 202 according to the present embodiment. As shown in FIG. 2, four antennas 211 (211A to 211D) are provided on a ceiling portion of the vehicle 202. The antenna 211A is provided on a front right side of the vehicle 202. The antenna 211B is provided on a front left side of the vehicle 202. The antenna 211C is provided on a rear right side of the vehicle 202. The antenna 211D is provided on a rear left side of the vehicle 202. In addition, a distance between the adjacent antennas 211 is set to be ½ or less of a wavelength 2 of the angle estimation signal to be described below. A local coordinate system of the communication unit 200 is set as a coordinate system based on the communication unit 200. An example of the local coordinate system of the communication unit 200 is a coordinate system in which the center of the four antennas 211 is set as the origin, a forward/backward direction of the vehicle 202 is set as an X-axis, a left/right direction of the vehicle 202 is set as a Y-axis, and a vertical direction of the vehicle 202 is set as a Z-axis. The X-axis is parallel to the axis connecting antenna pairs (e.g., the antennas 211A and 211C and the antennas 211B and 211D) in the forward/backward direction. Moreover, the Y-axis is parallel to the axis connecting the antenna pairs in the left/right direction (e.g., the antennas 211A and 211B and the antennas 211C and 211D).

An arrangement shape of the four antennas 211 is not limited to a square, but can be a parallelogram, a trapezoid, a rectangle, and any other shape. Of course, the number of antennas 211 is not limited to four.

FIG. 3 is a diagram showing an example of the location parameters of the portable device 100 according to the present embodiment. The location parameters may include a distance R between the portable device 100 and the communication unit 200. The distance R shown in FIG. 3 is a distance from the origin of the local coordinate system of the communication unit 200 to the portable device 100. The distance R is estimated on the basis of a transmission/reception result of the distance measurement signal to be described below between one of the plurality of wireless communication units 210 and the portable device 100. The distance R may be a distance from one wireless communication unit 210 that transmits and receives the distance measurement signal to be described below to the portable device 100.

Moreover, the location parameters may also include an angle of the portable device 100 with respect to the communication unit 200 consisting of an angle α from the X-axis to the portable device 100 and an angle β from the Y-axis to the portable device 100 shown in FIG. 3. The angles α and β are angles formed by a straight line connecting the origin and the portable device 100 in the first predetermined coordinate system and the coordinate axes. For example, the first predetermined coordinate system is the local coordinate system of the communication unit 200. The angle α is the angle formed by the straight line connecting the origin and the portable device 100 and the X-axis. The angle β is the angle formed by the straight line connecting the origin and the portable device 100 and the Y-axis.

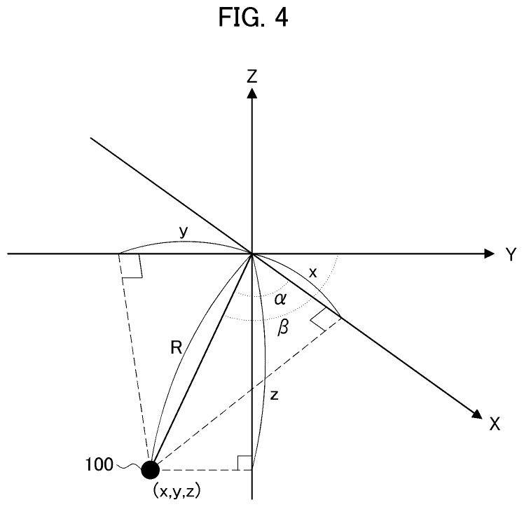

FIG. 4 is a diagram showing an example of the location parameters of the portable device 100 according to the present embodiment. The location parameters may include the coordinates of the portable device 100 in a second predetermined coordinate system. A coordinate x on the X-axis, a coordinate y on the Y-axis, and a coordinate z on the Z-axis of the portable device 100 shown in FIG. 4 are examples of such coordinates. That is, the second predetermined coordinate system may be a local coordinate system of the communication unit 200. In addition, the second predetermined coordinate system may be a global coordinate system.

### 2.2. CIR

### (1) CIR Calculation Process

The portable device 100 and the communication unit 200 perform communication for estimating the location parameters in the location parameter estimation process. At this time, the portable device 100 and the communication unit 200 calculate a channel impulse response (CIR).

The CIR is a response when an impulse is input to the system. The CIR in the present embodiment is calculated on the basis of a second signal that is a signal corresponding to a first signal received by the wireless communication unit of the other (hereinafter also referred to as a reception side) when the wireless communication unit of one (hereinafter also referred to as a transmission side) of the portable device 100 and the communication unit 200 transmits a signal including a pulse as the first signal. It can be said that the CIR indicates a characteristic of the wireless communication path between the portable device 100 and the communication unit 200. Hereinafter, the first signal is also referred to as a transmission signal and the second signal is also referred to as a reception signal.

As an example, the CIR may be a correlation calculation result that is a result of correlating the transmission signal and the reception signal at each specified time. The correlation here may be a sliding correlation that is a process in which the transmission signal and the reception signal are correlated while the relative location in each time direction is shifted. The CIR includes a correlation value indicating a height of the correlation between the transmission signal and the reception signal as an element for each time with a specified time interval. The specified time is, for example, an interval at which the reception side samples the reception signal. Therefore, the elements constituting the CIR are also referred to as sampling points. The correlation value may be a complex number with an IQ component. Moreover, the correlation value may also be the amplitude or phase of a complex number. Moreover, the correlation value may also be power, which is a sum of squares (or amplitude squares) of the I and Q components of the complex number.

The CIR can also be regarded as a set having a value at each time (hereinafter also referred to as a CIR value) as an element. In this case, the CIR is a time-series change in the CIR value. When the CIR is a correlation calculation result, the CIR value is a correlation value.

As another example, the CIR may be a reception signal (a complex number having an IQ component) itself at each specified time. Moreover, the CIR may also be the amplitude or phase of the reception signal for each specified time. Moreover, the CIR may be a power value that is a sum of squares of the I component and the Q component of the reception signal for each specified time.

In addition, the portable device 100 and the communication unit 200 acquire the time using a time counter. The time counter is a counter that counts (typically increments) a value indicating the elapsed time (hereinafter also referred to as a count value) at a predetermined time interval (hereinafter also referred to as a count cycle). The current time is calculated on the basis of the count value counted by the time counter, the count cycle, and the count start time. A state for a case where the count cycle and the count start time coincide between different devices is also referred to as a synchronous state. On the other hand, a state for a case where at least one of the count cycle and the count start time is different between different devices is also referred to as a nonsynchronous or asynchronous state. The portable device 100 and the communication unit 200 may be synchronous or asynchronous. Moreover, the plurality of wireless communication units 210 may be mutually synchronous or asynchronous. The above-described specified time for calculating the CIR may be an integer multiple of the count cycle of the time counter. In the following description, unless otherwise stated, a case where the portable device 100 and each of the plurality of wireless communication units 210 are mutually synchronous.

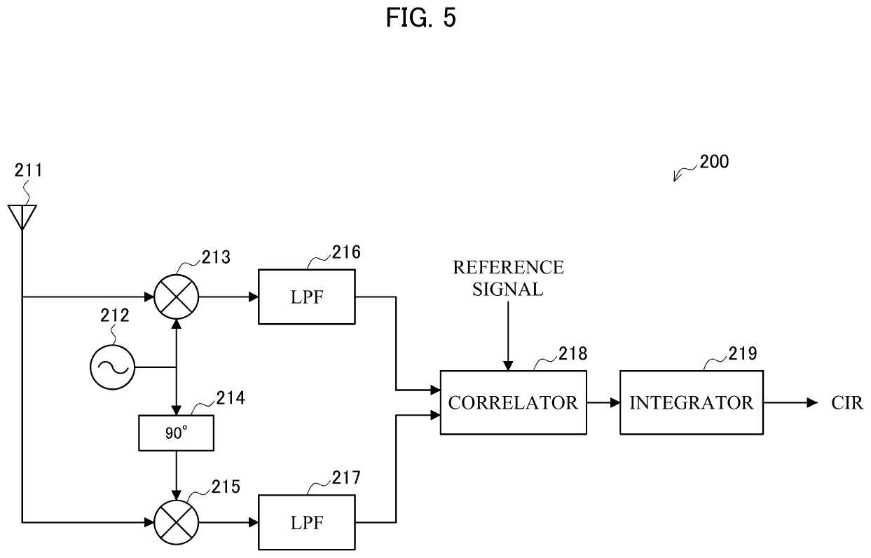

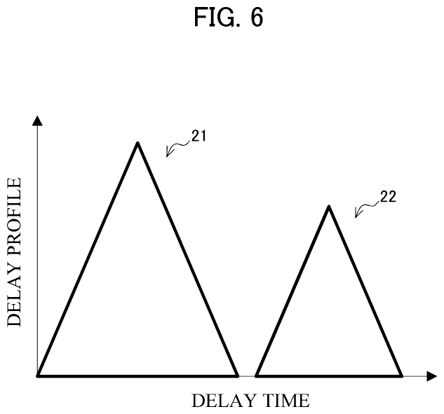

Hereinafter, a CIR calculation process for a case where the transmission side is the portable device 100 and the reception side is the communication unit 200 will be described in detail with reference to FIGS. 5 and 6.

FIG. 5 is a diagram showing an example of a signal processing block in the communication unit 200 according to the present embodiment. As shown in FIG. 5, the communication unit 200 includes an oscillator 212, a multiplier 213, a 90-degree phase shifter 214, a multiplier 215, a low pass filter (LPF) 216, an LPF 217, a correlator 218, and an integrator 219.

The oscillator 212 generates a signal having a frequency equal to the frequency of a carrier wave for carrying a transmission signal and outputs the generated signal to the multiplier 213 and the 90-degree phase shifter 214.

The multiplier 213 multiplies the reception signal received by the antenna 211 by the signal output from the oscillator 212 and outputs a multiplication result to the LPF 216. The LPF 216 outputs a signal having a frequency equal to or less than the frequency of the carrier wave carrying the transmission signal among input signals to the correlator 218. The signal input from the LPF 216 to the correlator 218 is an I component (i.e., a real part) among the components corresponding to the envelope of the reception signal.

The 90-degree phase shifter 214 delays a phase of the input signal by 90 degrees and outputs a delayed signal to the multiplier 215. The multiplier 215 multiplies the reception signal received by the antenna 211 by the signal output from the 90-degree phase shifter 214 and outputs a multiplication result to the LPF 217. The LPF 217 outputs a signal having a frequency equal to or less than the frequency of the carrier wave carrying the transmission signal among the input signals to the correlator 218. The signal input from the LPF 216 to the correlator 218 is a Q component (i.e., an imaginary part) among the components corresponding to the envelope of the reception signal.

The correlator 218 calculates the CIR by performing a sliding correlation between the reception signal consisting of the I component and the Q component and the reference signal output from the LPF 216 and LPF 217. In addition, the reference signal here is the same as the transmission signal before the carrier wave is multiplied. The integrator 219 integrates CIRs output from the correlator 218 to output an integrated CIR.

Here, the transmission side may transmit a signal including a plurality of preambles, each of which includes one or more preamble symbols, as a transmission signal. The preamble is a sequence known between transmission and reception. The preamble is typically placed at the beginning of the transmission signal. A preamble symbol is a pulse sequence including one or more pulses. The pulse sequence is a set of a plurality of pulses separated in the time direction. The preamble symbol is a target of integration by the integrator 219. That is, the correlator 218 calculates a CIR for each preamble symbol by performing a sliding correlation between each of parts corresponding to a plurality of preamble symbols included in the reception signal and the preamble symbol included in the transmission signal (i.e., a reference signal). Also, the integrator 219 integrates CIRs for preamble symbols for one or more preambles included in the preamble and outputs an integrated CIR.

### (2) Example of CIR

FIG. 6 shows an example of the CIR output from the integrator 219. FIG. 6 is a graph showing an example of the CIR according to the present embodiment. The CIR shown in FIG. 6 is a CIR for a case where the time when the transmission side transmitted the transmission signal is assumed to be the count start time of the time counter. Such a CIR is also referred to as a delay profile. The horizontal axis of this graph represents a delay time. The delay time is the elapsed time from the time when the transmission side transmitted the transmission signal. The vertical axis of this graph represents an absolute value of a CIR value (e.g., a power value). In the following description, the CIR will be referred to as a delay profile.

One information item constituting information that changes over time like a CIR value of a certain delay time in the CIR is also referred to as a sampling point. Typically, in the CIR, a set of sampling points between zero-crossing points corresponds to a pulse. The CIR shown in FIG. 6 includes a set 21 of sampling points corresponding to one pulse and a set 22 of sampling points corresponding to another pulse.

The set 21 corresponds, for example, to a signal (e.g., a pulse) that has arrived at the reception side via a fast path. The fast path refers to a shortest path between transmission and reception. The fast path refers to a straight path between transmission and reception in an unobstructed environment. The set 22 corresponds, for example, to a signal (e.g., a pulse) that has arrived at the reception side through a path other than the fast path. In this way, a signal arriving via a plurality of paths is also referred to as a multipath wave.

### (3) Detection of First Arrival Wave

The reception side detects a signal satisfying a predetermined detection criterion among radio signals received from the transmission side as a signal that has reached the reception side via the fast path. Also, the reception side estimates location parameters on the basis of the detected signal.

The signal detected as a signal that has reached the reception side via the fast path is also referred to as a first arrival wave hereinafter. The first arrival wave can be any of a direct wave, a delayed wave, and a composite wave. The direct wave is a signal that is received directly (i.e., without reflection or the like) at the reception side via the shortest path between transmission and reception. That is, the direct wave is a signal that has reached the reception side via the fast path. The delayed wave is a signal received indirectly by the reception side via a path that is not the shortest path between transmission and reception, i.e., reflection or the like. Compared to the direct wave, the delayed wave is delayed and received by the reception side. The composite wave is a signal received by the reception side in a state in which a plurality of signals passing through a plurality of different paths are combined.

The reception side detects a signal that satisfies the predetermined detection criterion among the radio signals received from the transmission side as the first arrival wave. An example of a predetermined detection criterion is that the power value of the CIR first exceeds a predetermined threshold value. That is, the reception side may detect a pulse corresponding to a portion of the CIR whose power value first exceeds a predetermined threshold value as the first arrival wave. Another example of the predetermined detection criterion is that the received power value of the received radio signal (i.e., a sum of squares of the I and Q components of the reception signal) initially exceeds a predetermined threshold value. That is, the reception side may detect a signal whose received power value initially exceeds a predetermined threshold value among the reception signals as the first arrival wave.

It should be noted here that the signal detected as the first arrival wave is not necessarily the direct wave. For example, when the direct wave is received in a state in which the delayed wave is canceled out, the power value of the CIR may fall below a predetermined threshold value and the direct wave may not be detected as the first arrival wave. In this case, the delayed wave or the composite wave that arrives later than the direct wave is detected as the first arrival wave.

### 2.3. Estimation of Location Parameters

### (1) Distance Estimation

The communication unit 200 performs a distance measurement process.

The distance measurement process is a process of estimating the distance between the communication unit 200 and the portable device 100. The distance between the communication unit 200 and the portable device 100 is, for example, a distance R shown in FIG. 3. The distance measurement process includes transmitting and receiving a distance measurement signal and calculating the distance R on the basis of the propagation delay time of the distance measurement signal. The propagation delay time is a period of time required until a signal is transmitted and received.

Here, any one of the plurality of wireless communication units 210 provided in the communication unit 200 transmits and receives a distance measurement signal. The wireless communication unit 210 that transmits and receives the distance measurement signal is also referred to as a master hereinafter. The distance R is a distance between the wireless communication unit 210 (more precisely, the antenna 211) functioning as a master and the portable device 100.

In the distance measurement process, a plurality of distance measurement signals can be transmitted and received between the communication unit 200 and the portable device 100. Among the plurality of distance measurement signals, the distance measurement signal transmitted from one device to the other device is also referred to as the first distance measurement signal. Next, the distance measurement signal transmitted from the device that has received the first distance measurement signal to the device that has transmitted the first distance measurement signal as a response to the first distance measurement signal is also referred to as a second distance measurement signal. Next, the distance measurement signal transmitted from the device that has received the second distance measurement signal to the device that has transmitted the second distance measurement signal as a response to the second distance measurement signal is also referred to as a third distance measurement signal.

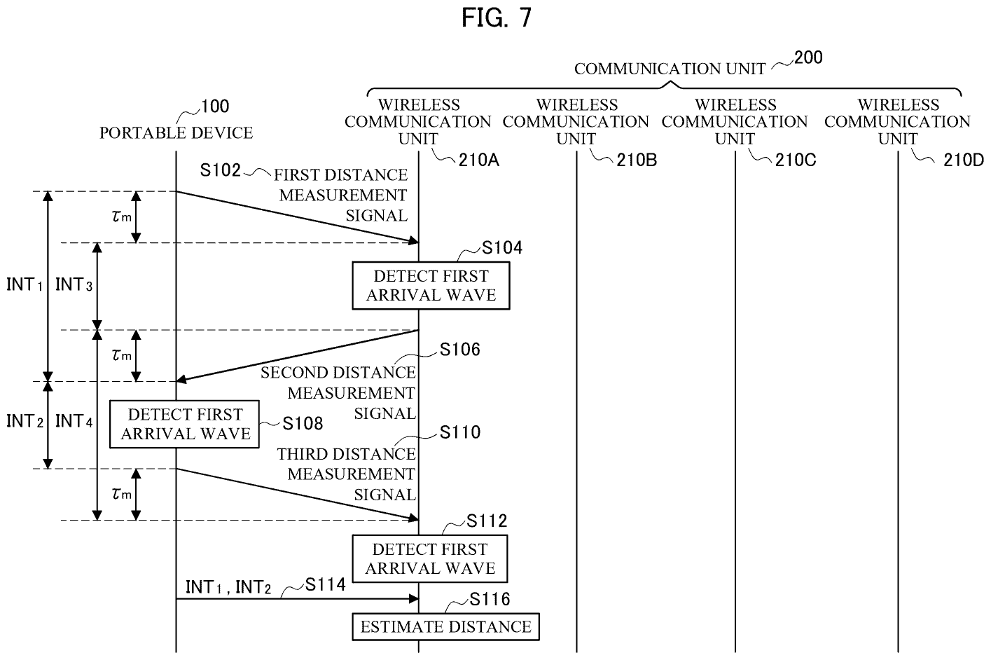

Hereinafter, an example of the flow of the distance measurement process will be described with reference to FIG. 7.

FIG. 7 is a sequence diagram showing an example of the flow of a distance measurement process executed in the system 1 according to the present embodiment. The sequence involves a portable device 100 and a communication unit 200. In this sequence, the wireless communication unit 210A functions as a master.

As shown in FIG. 7, first, the portable device 100 transmits a first distance measurement signal (step S102). When the first distance measurement signal is received by the wireless communication unit 210A, the control unit 230 calculates a CIR of the first distance measurement signal. Subsequently, the control unit 230 detects a first arrival wave of the first distance measurement signal in the wireless communication unit 210A on the basis of the calculated CIR (step S104).

Subsequently, the wireless communication unit 210A transmits a second distance measurement signal as a response to the first distance measurement signal (step S106). When the second distance measurement signal is received, the portable device 100 calculates the CIR of the second distance measurement signal. Subsequently, the portable device 100 detects the first arrival wave of the second distance measurement signal on the basis of the calculated CIR (step S108).

Subsequently, the portable device 100 transmits a third distance measurement signal as a response to the second distance measurement signal (step S110). When the third distance measurement signal is received by the wireless communication unit 210A, the control unit 230 calculates a CIR of the third distance measurement signal. Subsequently, the control unit 230 detects a first arrival wave of the third distance measurement signal in the wireless communication unit 210A on the basis of the calculated CIR (step S112).

The portable device 100 measures a time period INT₁ from the transmission time of the first distance measurement signal to the reception time of the second distance measurement signal and a time period INT₂ from the reception time of the second distance measurement signal to the transmission time of the third distance measurement signal. Here, the reception time of the second distance measurement signal is the reception time of the first arrival wave of the second distance measurement signal detected in step S108. Also, the portable device 100 transmits a signal including information indicating the time periods INT₁ and INT₂ (step S114). Such a signal is received, for example, by the wireless communication unit 210A.

The control unit 230 measures a time period INT₃ from the reception time of the first distance measurement signal to the transmission time of the second distance measurement signal and a time period INT₄ from the transmission time of the second distance measurement signal to the reception time of the third distance measurement signal. Here, the reception time of the first distance measurement signal is the reception time of the first arrival wave of the first distance measurement signal detected in step S104. Likewise, the reception time of the third distance measurement signal is the reception time of the first arrival wave of the third distance measurement signal detected in step S112.

Also, the control unit 230 estimates a distance R based on the time periods INT₁, INT₂, INT₃, and INT₄ (step S116). For example, the control unit 230 estimates a propagation delay time τₘ by the following equation.

$$\begin{matrix}[ Math . 1 ] & \\ {τ}_{m} = \frac{{INT}_{1} \times {INT}_{4} - {INT}_{2} \times {INT}_{3}}{IN {T}_{1} + {INT}_{2} + IN {T}_{3} + I N {T}_{4}} & ( 1 )\end{matrix}$$

Subsequently, the control unit 230 estimates the distance R by multiplying the estimated propagation delay time τₘ by a rate of the signal.

### —Cause of Deterioration in Estimation Accuracy

The reception time of the distance measurement signal that is the beginning or end of the time periods INT₁, INT₂, INT₃, and INT₄ is the reception time of the first arrival wave of the distance measurement signal. As described above, the signal detected as the first arrival wave is not necessarily a direct wave.

When a delayed wave or a composite wave arriving later than the direct wave is detected as the first arrival wave, the reception time of the first arrival wave is delayed compared to the case where the direct wave is detected as the first arrival wave. In this case, the estimation result of the propagation delay time τₘ varies from a true value (an estimation result for a case where the direct wave is detected as the first arrival wave). Also, as the change increases, the distance measurement accuracy decreases.

### —Supplement

In addition, the reception side may use the time when the predetermined detection criterion is satisfied as the reception time of the first arrival wave. That is, the reception side may set the time when the power value of the CIR initially exceeds a predetermined threshold value or the time when the received power value of the received radio signal initially exceeds a predetermined threshold value, as the reception time of the first arrival wave. In addition, the reception side may use the peak time of the detected first arrival wave (i.e., the time when the power value is highest in the portion corresponding to the first arrival wave in the CIR or the time when the received power value is highest in the first arrival wave) as the reception time of the first arrival wave.

### (2) Angle Estimation

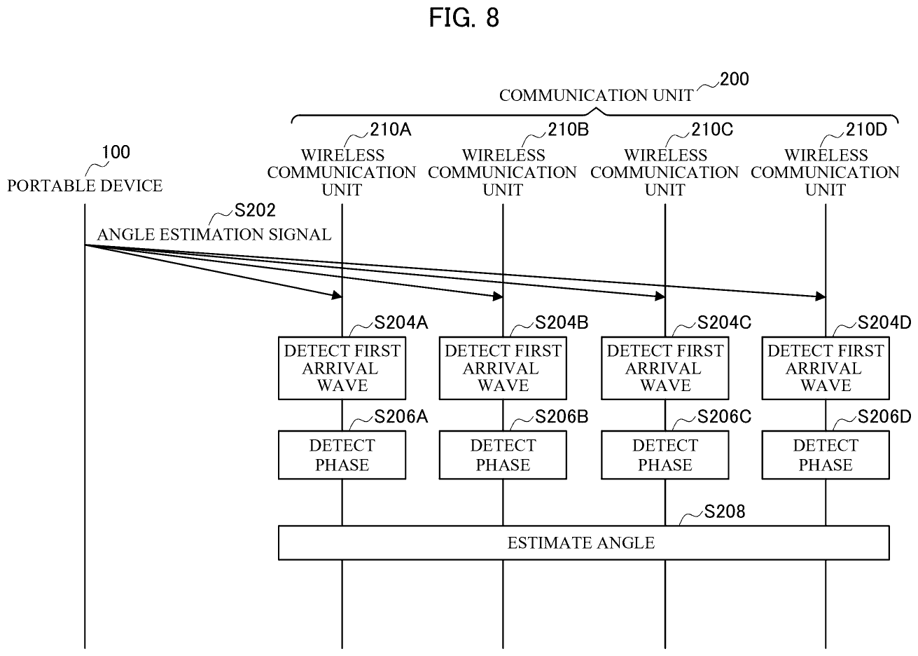

The communication unit 200 performs an angle estimation process. The angle estimation process is a process of estimating the angles α and β shown in FIG. 3. The angle acquisition process includes receiving an angle estimation signal and calculating the angles α and β on the basis of a result of receiving the angle estimation signal. The angle estimation signal is a signal transmitted and received in the angle estimation process. Hereinafter, an example of the flow of the angle estimation process will be described with reference to FIG. 8.

FIG. 8 is a sequence diagram showing an example of the flow of the angle estimation process executed in the system 1 according to the present embodiment. The present sequence involves the portable device 100 and the communication unit 200.

As shown in FIG. 8, first, the portable device 100 transmits an angle estimation signal (step S202). Subsequently, when the angle estimation signal is received by each of the wireless communication units 210A to 210D, the control unit 230 calculates a CIR of the angle estimation signal received by each of the wireless communication units 210A to 210D. Subsequently, the control unit 230 detects the first arrival wave of the angle estimation signal on the basis of the calculated CIR with respect to each of the wireless communication units 210A to 210D (steps S204A to S204D). Subsequently, the control unit 230 detects a phase of the detected first arrival wave for each of the wireless communication units 210A to 210D (steps S206A to S206D). Also, the control unit 230 estimates the angles α and β on the basis of the phase of the first arrival wave detected for each of the wireless communication units 210A to 210D (step S208).

Here, the phase of the first arrival wave is the phase of the CIR at the reception time of the first arrival wave. In addition, the phase of the first arrival wave may be the phase at the reception time of the first arrival wave among the received radio signals.

Hereinafter, details of processing in step S208 will be described. A phase of the first arrival wave detected for the wireless communication unit 210A is P_{A}. A phase of the first arrival wave detected for the wireless communication unit 210B is P_{B}. A phase of the first arrival wave detected for the wireless communication unit 210C is P_{C}. A phase of the first arrival wave detected for the wireless communication unit 210D is P_{D}. In this case, the antenna array phase differences Pd_{AC} and Pd_{BD} in the X-axis direction and the antenna array phase differences Pd_{BA} and Pd_{DC} in the Y-axis direction are represented by the following equations, respectively.

$$\begin{matrix}[ Math . 2 ] & \\ \begin{matrix}P {d}_{A C} = ( {P}_{A} - {P}_{C} ) \\ {Pd}_{B D} = ( {P}_{B} - {P}_{D} ) \\ {Pd}_{D C} = ( {P}_{D} - {P}_{C} ) \\ {Pd}_{BA} = ( {P}_{B} - {P}_{A} )\end{matrix} & ( 2 )\end{matrix}$$

The angles α and β are calculated by the following equation. Here, λ denotes a wavelength of a radio wave and d denotes a distance between the antennas 211.

$$\begin{matrix}[ Math . 3 ] & \\ α or β = arc cos ( λ \cdot Pd / ( 2 \cdot π \cdot d ) ) & ( 3 )\end{matrix}$$

Therefore, angles calculated on the basis of antenna array phase differences are expressed by the following equations.

$$\begin{matrix}[ Math . 4 ] & \\ \begin{matrix}{α}_{A C} = arc cos ( λ \cdot {Pd}_{A C} / ( 2 \cdot π \cdot d ) ) \\ {α}_{BD} = arc cos ( λ \cdot {Pd}_{B D} / ( 2 \cdot π \cdot d ) ) \\ {β}_{D C} = arc cos ( λ \cdot {Pd}_{D C} / ( 2 \cdot π \cdot d ) ) \\ {β}_{BA} = arc cos ( λ \cdot {Pd}_{B A} / ( 2 \cdot π \cdot d ) )\end{matrix} & ( 4 )\end{matrix}$$

The control unit 230 calculates the angles α and β on the basis of the calculated angles α_{AC}, β_{BD}, β_{DC}, and β_{BA}. For example, the control unit 230 calculates the angles α and β by averaging the angles calculated for the two arrays in the X- and Y-axis directions as shown in the following equations.

$$\begin{matrix}[ Math . 5 ] & \\ \begin{matrix}α = ( {α}_{A C} + {α}_{B D} ) / 2 \\ β = ( {β}_{D C} + {β}_{B A} ) / 2\end{matrix} & ( 5 )\end{matrix}$$

### —Cause of Deterioration in Estimation Accuracy

As described above, the angles α and β are calculated on the basis of the phase of the first arrival wave. As described above, the signal detected as the first arrival wave is not necessarily a direct wave.

That is, a delayed wave or a composite wave may be detected as the first arrival wave. Typically, because the phases of the delayed wave and the composite wave are different from the phase of the direct wave, the angle estimation accuracy is decreased by a difference amount.

### —Supplement

The angle estimation signal and the distance measurement signal may be the same. For example, the third distance measurement signal shown in FIG. 7 and the angle estimation signal shown in FIG. 8 may be the same. In this case, the communication unit 200 can calculate the distance R and the angles α and β by receiving a radio signal that serves as both an angle estimation signal and a second distance measurement signal.

### (3) Coordinate Estimation

The control unit 230 performs a coordinate estimation process. As the coordinate estimation process, which is a process of estimating the three-dimensional coordinates (x, y, z) of the portable device 100 shown in FIG. 4, the following first and second calculation methods may be adopted.

### —First Calculation Method

The first calculation method is a method for calculating coordinates x, y, and z on the basis of results of the distance measurement process and the angle estimation process. In this case, first, the control unit 230 calculates the coordinates x and y by the following equations.

$$\begin{matrix}[ Math . 6 ] & \\ x = R \cdot cos α y = R \cdot cos β & ( 6 )\end{matrix}$$

Here, a relationship of the following equation is valid for the distance R and the coordinates x, y, and z.

$$\begin{matrix}[ Math . 7 ] & \\ R = \sqrt{{x}^{2} + {y}^{2} + {z}^{2}} & ( 7 )\end{matrix}$$

The control unit 230 calculates the coordinate z by the following equation using the above relationship.

$$\begin{matrix}[ Math . 8 ] & \\ z = \sqrt{{R}^{2} - {R}^{2} \cdot {cos}^{2} α - R \cdot {cos}^{2} β} & ( 8 )\end{matrix}$$

### —Second Calculation Method

The second calculation method is a method for calculating coordinates x, y, and z by omitting the estimation of the angles α and β. First, the relationship of the following equations is valid according to the above Eqs. (4), (5), (6), and (7).

$$\begin{matrix}[ Math . 9 ] & \\ x / R = cos α & ( 9 )\end{matrix}$$

$$\begin{matrix}[ Math . 10 ] & \\ y / R = cos β & ( 10 )\end{matrix}$$

$$\begin{matrix}[ Math . 11 ] & \\ {x}^{2} + {y}^{2} + {z}^{2} = {R}^{2} & ( 11 )\end{matrix}$$

$$\begin{matrix}[ Math . 12 ] & \\ d \cdot cos α = λ \cdot ( {Pd}_{A C} / 2 + P {d}_{B D} / 2 ) / ( 2 \cdot π ) & ( 12 )\end{matrix}$$

$$\begin{matrix}[ Math . 13 ] & \\ d \cdot cos β = λ \cdot ( {Pd}_{D C} / 2 + P {d}_{BA} / 2 ) / ( 2 \cdot π ) & ( 13 )\end{matrix}$$

When Eq. (12) is arranged with respect to cos α and substituted into Eq. (9), the coordinate x is obtained by the following equation.

$$\begin{matrix}[ Math . 14 ] & \\ x = R \cdot λ \cdot ( {Pd}_{A C} / 2 + P {d}_{BD} / 2 ) / ( 2 \cdot π \cdot d ) & ( 14 )\end{matrix}$$

When Eq. (13) is arranged with respect to cos β and substituted into Eq. (10), the coordinate y is obtained by the following equation.

$$\begin{matrix}[ Math . 15 ] & \\ y = R \cdot λ \cdot ( {Pd}_{D C} / 2 + P {d}_{BA} / 2 ) / ( 2 \cdot π \cdot d ) & ( 15 )\end{matrix}$$

Also, when Eq. (14) and Eq. (15) are arranged by substituting Eq. (11), the coordinate z is obtained by the following equation.

$$\begin{matrix}[ Math . 16 ] & \\ z = \sqrt{{R}^{2} - {x}^{2} - {y}^{2}} & ( 16 )\end{matrix}$$

As described above, the estimation process on the coordinates of the portable device 100 in the local coordinate system has been described. By combining the coordinates of the portable device 100 in the local coordinate system and the coordinates of the origin of the local coordinate system in the global coordinate system, the coordinates of the portable device 100 in the global coordinate system can also be estimated.

### —Cause of Deterioration in Estimation Accuracy

As described above, the coordinates are calculated on the basis of the propagation delay time and phase. Also, all of these are estimated on the basis of the first arrival wave. Therefore, for a reason similar to those of the distance measurement process and the angle estimation process, the coordinate estimation accuracy can deteriorate.

### (4) Estimation of Region of Existence

The location parameter may include a region where the portable device 100 is located among a plurality of predefined regions. As an example, when the region is defined by the distance from the communication unit 200, the control unit 230 estimates a region where the portable device 100 is located on the basis of the distance R estimated by the distance measurement process. As another example, when the region is defined by an angle from the communication unit 200, the region where the portable device 100 is located is estimated on the basis of the angles α and β estimated by the control unit 230 and the angle estimation process. As another example, when the region is defined by three-dimensional coordinates, the control unit 230 estimates the region where the portable device 100 is located on the basis of the coordinates (x, y, z) estimated by the coordinate estimation process.

In addition, as a process unique to the vehicle 202, the control unit 230 may estimate the region where the portable device 100 is located from a plurality of regions including the interior and exterior of the vehicle 202. Thereby, it is possible to provide detailed services such as providing different services when the user is in the vehicle interior and the vehicle exterior. In addition, the control unit 230 may identify a region where the portable device 100 is located from a nearby region that is a region within a predetermined distance from the vehicle 202 and a distant region that is a region of a predetermined distance or more from the vehicle 202.

### (5) Application of Location Parameter Estimation Result

The location parameter estimation result can be used, for example, for authentication of the portable device 100. For example, when the portable device 100 is located on the driver's seat side and in a region close to the communication unit 200, the control unit 230 determines that authentication is successful and unlocks the door.

### 3. Technical Issues

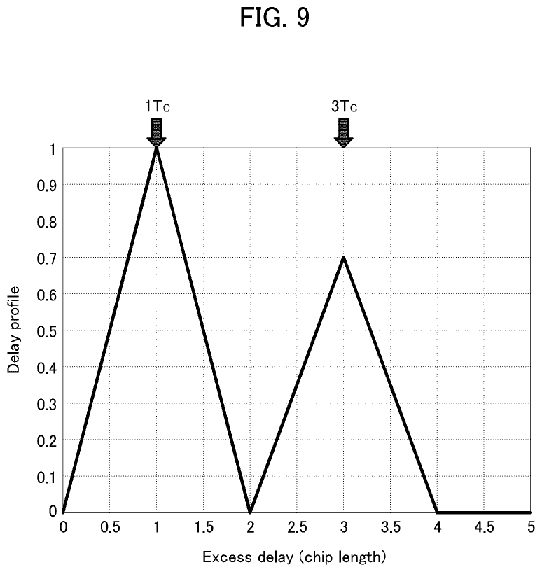

The technical issues of the present embodiment will be described with reference to FIGS. 9 to 12. FIGS. 9 to 12 are explanatory graphs of the technical issues of the present embodiment. The horizontal axis represents a chip length indicating a delay time and the vertical axis represents an absolute value of a CIR value (e.g., a power value). The chip length is a time width per pulse. For example, when a pulse with a bandwidth of 500 MHz is created, the pulse width of approximately 2 ns becomes the chip length.

In FIG. 9, a CIR for a case where a signal arrives via the fast path at a delay time of 1 T_{C} and a signal arrives via a path other than the fast path at a delay time of 3 T_{C} is shown. Referring to FIG. 9, there is a peak in the CIR waveform at each of the delay times of 1 T_{C} and 3 T_{C}. Therefore, it can be seen that the separation of two multipath waves with a delay time of 2 T_{C} is sufficiently implemented in the CIR waveform.

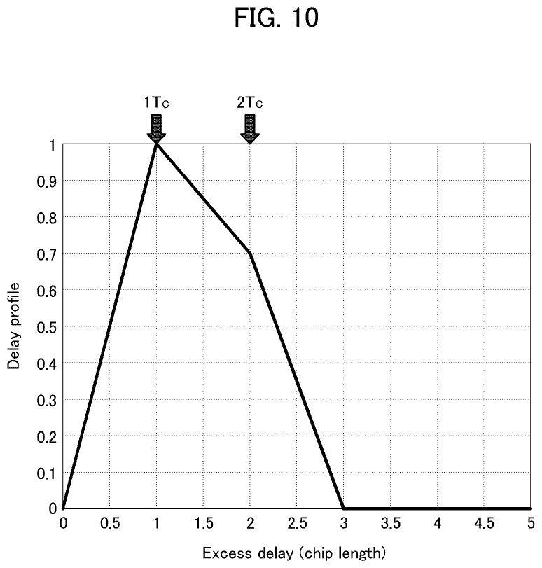

In FIG. 10, a CIR for a case where a signal arrives via the fast path at a delay time of 1 T_{C} and a signal arrives via a path other than the fast path at a delay time of 2 T_{c} is shown. In addition, the signal of the first wave arriving at a delay time of 1 T_{C} and the signal of the second wave arriving at a delay time of 2 T_{C} are in phase. Referring to FIG. 10, while the CIR waveform has a peak at the delay time of 1 T_{C}, there is no peak in the CIR waveform at the delay time of 2 T_{C}. Furthermore, the signal arriving at the delay time of 1 T_{C} and the signal arriving at the delay time of 2 T_{C} are combined in phase and appear as a single waveform. Therefore, it can be seen that the implementation of the separation of two multipath waves with a delay time of 1 T_{C} is difficult in a CIR waveform.

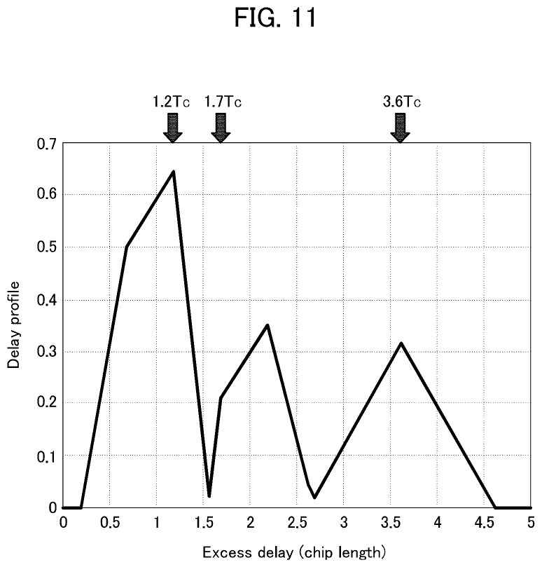

In FIG. 11, a CIR for a case where a signal arrives via the fast path at a delay time of 1.2 T_{C} and signals arrive via a path other than the fast path at delay times of 1.7 T_{C} and 3.6 T_{C} is shown. The signal of the first wave arriving at the delay time of 1.2 T_{C} and the signal of the second wave arriving at the delay time of 1.7 T_{C} are in antiphase. Referring to FIG. 11, there is a peak in the CIR waveform at delay times of 1.2 T_{C} and 3.6 T_{C}. On the other hand, a second peak stands around the delay time of 2.2 T_{C}. This is significantly away from the true delay time of 1.7 T_{C}. Therefore, it can be seen that the implementation of the separation of two multipath waves with a delay time of 0.5 T_{C} is difficult in a CIR waveform.

As shown in FIGS. 10 and 11, if a delay time difference between the two multipath waves arriving at the reception side is short, the peak delay time in the CIR waveform may vary from the original delay time. Therefore, the delay time detected as the reception time of the first arrival wave can vary from the original delay time. In this case, the distance measurement accuracy is decreased by an amount of variation.

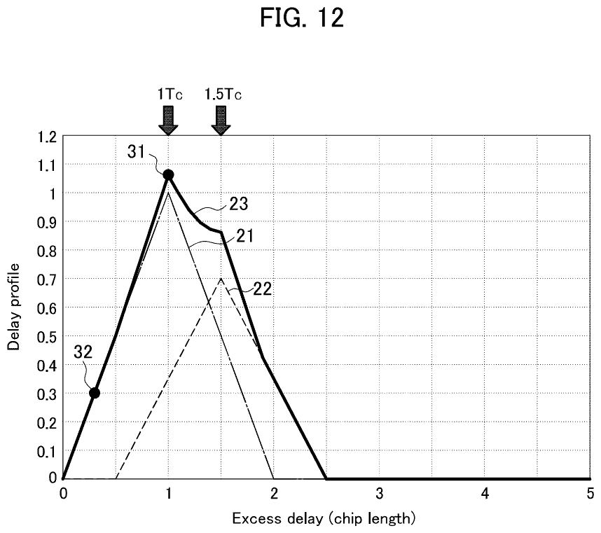

In FIG. 12, a CIR waveform 23 for a case where a signal arrives via the fast path at a delay time of 1 T_{C} and a signal arrives via a path other than the fast path at a delay time of 1.5 T_{C} is shown. A CIR waveform 21 is a CIR waveform for a case where a signal is received solely via the fast path at a delay time of 1 T_{C}. A CIR waveform 22 is a CIR waveform for a case where a signal is received solely via a path other than the fast path at a delay time of 1.5 T_{C}. A phase deviation of 90 degrees is between the signal of the first wave arriving at a delay time of 1 T_{C} and the signal of the second wave arriving at a delay time of 2 T_{C}.

When a delay time difference between the two multipath waves arriving at the reception side is short, a delayed wave or a composite wave may be detected as the first arrival wave. In the example shown in FIG. 12, the composite wave is detected as the first arrival wave. Typically, because the phases of the delayed wave and the composite wave are different from the phase of the direct wave, the angle estimation accuracy is decreased by the difference.

As shown in the example shown in FIG. 12, when a composite wave of a direct wave and a delayed wave is detected as the first arrival wave, the phase fluctuates greatly due to the combination of the delayed wave at the sampling point 31 near the peak. Therefore, when the angle is estimated on the basis of the phase at the sampling point 31, the estimation accuracy is reduced.

On the other hand, at a low-power sampling point before the peak like the sampling point 32, because the influence of the delayed wave decreases, the phase fluctuation becomes small. However, while the influence of the delayed wave decreases, the power value also decreases, leading to an increase in the influence of noise and a decrease in the estimation accuracy.

Therefore, it is desirable to enable the separation of multipath waves with a higher resolution than that of the CIR.

### 4. Technical Features

### 4.1. Detection of First Arrival Wave

The portable device 100 and the communication unit 200 detect the first arrival wave by the process described in detail below. Hereinafter, as an example, a case where an entity for detecting the first arrival wave is the communication unit 200 will be described. The process to be described below may be performed by the portable device 100.

### (1) Formulation of Delay Profile

First, the delay profile (i.e., the CIR) in a pseudo-noise (PN) correlation method is formulated. The PN correlation method is a method for calculating a CIR by transmitting a signal consisting of a random sequence such as a PN sequence signal shared by the transmission and reception sides and performing a sliding correlation between the transmission signal and the reception signal. In addition, the PN sequence signal is a signal in which 1 and 0 are arranged almost randomly.

Hereinafter, it is assumed that a PN sequence signal u(t) having a unit amplitude is transmitted as a transmission signal (e.g., a preamble symbol for a distance measurement signal and an angle estimation signal). The unit amplitude is a known specified amplitude between transmission and reception.

Moreover, hereinafter, it is assumed that the antenna on the reception side receives multipath waves that are L waves as a signal corresponding to the transmission signal transmitted from the transmission side. Multipath waves are a signal received by the reception side via a plurality of paths. That is, when the transmission side transmits a signal, L signals are received via a plurality of paths at the reception side.

In this case, a reception signal x(t) is expressed by the following equation.

$$\begin{matrix}[ Math . 17 ] & \\ x ( t ) = {\sum }_{i = 1}^{L} {h}_{i} u ( t - {T}_{0 i} ) {e}^{- j 2 π {fT}_{0 i}} + v ( t ) & ( 17 )\end{matrix}$$

Here, t denotes time. hᵢ denotes a complex response value of an i^{th} multipath wave. T₀ᵢ denotes a propagation delay time of the i^{th} multipath wave. f denotes a frequency of a carrier wave of the transmission signal. v(t) denotes internal noise. The internal noise is noise generated inside the circuit on the receiver side.

For example, in the PN correlation method, a correlation with the reception signal x(t) is performed while the time of the transmission signal u(t) known on the receiver side is shifted as shown in the following equation.

$$\begin{matrix}[ Math . 18 ] & \\ z ( τ ) = \frac{1}{T} {\int }_{0}^{T} {u}^{*} ( t - τ ) x ( t ) d t & ( 18 )\end{matrix}$$

In addition, u*( ) denotes a complex conjugate of u( ).

z(τ) is also referred to as a delay profile. Moreover, |z(τ)|² is also referred to as a power delay profile. τ denotes a delay time.

The delay profile of the multipath waves that are the L waves is expressed by the following equation.

$$\begin{matrix}[ Math . 19 ] & \\ z ( τ ) = {\sum }_{i = 1}^{L} {h}_{i} {e}^{- j 2 π {fT}_{0 i}} r ( τ - {T}_{0 i} ) + n ( τ ) & ( 19 )\end{matrix}$$

Here, r(τ) denotes an autocorrelation function of the PN sequence signal. The autocorrelation function is a function of correlating a signal with itself. r(τ) is given by the following equation.

$$\begin{matrix}[ Math . 20 ] & \\ r ( τ ) = \frac{1}{T} {\int }_{0}^{T} {u}^{*} ( t - τ ) u ( t ) dt & ( 20 )\end{matrix}$$

Moreover, n(τ) denotes an internal noise component. n(τ) is given by the following equation.

$$\begin{matrix}[ Math . 21 ] & \\ n ( τ ) = {\int }_{0}^{T} {u}^{*} ( t - τ ) v ( t ) dt & ( 21 )\end{matrix}$$

### (2) Sparse Reconstruction

It is assumed that the number of samples of the reception signal is M (where M>L). Also, it is assumed that the reception signal is sampled at M discrete delay times τ₁, τ₂, . . . , τ_{M}. The delay discrete time is expressed as a discrete value of the delay time. z(τ) denotes a delay profile calculated on the basis of the reception signal sampled at the discrete delay time t. A data vector z consisting of M delay profiles is expressed by the following equation. However, the following equation is an equation for a case where the reception side receives only a preamble symbol.

$$\begin{matrix}[ Math . 22 ] & \\ z = {[ z ( {τ}_{1} ) , z ( {τ}_{2} ) , ⋯ , z ( {τ}_{M} ) ]}^{T} & ( 22 )\end{matrix}$$

When multipath waves that are L waves are received, the data vector z is expressed as follows.

$$\begin{matrix}[ Math . 23 ] & \\ z = {\sum }_{i = 1}^{L} {h}_{i} {e}^{- j 2 π {fT}_{0 i}} r ( {T}_{0 i} ) + n & ( 23 )\end{matrix}$$

$$\begin{matrix}[ Math . 24 ] & \\ r ( τ ) = {[ r ( {τ}_{1} - τ ) , r ( {τ}_{2} - τ ) , ⋯ , r ( {τ}_{M} - τ ) ]}^{T} & ( 24 )\end{matrix}$$

$$\begin{matrix}[ Math . 25 ] & \\ n = {[ n ( {τ}_{1} ) , n ( {τ}_{2} ) , ⋯ , n ( {τ}_{M} ) ]}^{T} & ( 25 )\end{matrix}$$

In addition, r(τ) is referred to as a distance mode vector.

Furthermore, when the data vector z is expressed in matrix notation, it is expressed as the following equation.

$$\begin{matrix}[ Math . 26 ] & \\ z = {A}_{0} {s}_{0} + n ∈ {ℂ}^{M} & ( 26 )\end{matrix}$$

$$\begin{matrix}[ Math . 27 ] & \\ {A}_{0} = [ r ( {T}_{01} ) , r ( {T}_{02} ) , , r ( {T}_{0 L} ) ] ∈ {ℂ}^{M \times L} & ( 27 )\end{matrix}$$

$$\begin{matrix}[ Math . 28 ] & \\ {s}_{0} = {[ {h}_{1} {e}^{- j 2 π {fT}_{01}} , {h}_{2} {e}^{- j 2 π {fT}_{02}} , , {h}_{L} {e}^{- j 2 π {fT}_{0 L}} ]}^{T} ∈ {ℂ}^{L} & ( 28 )\end{matrix}$$

Here, A₀ is also referred to as a mode matrix.

Moreover, S₀ is also referred to as a signal vector.

In sparse reconstruction, the data vector z is converted into a format including a matrix product of A and s.

$$\begin{matrix}[ Math . 29 ] & \\ z = As + n ∈ {ℂ}^{M} & ( 29 )\end{matrix}$$

$$\begin{matrix}[ Math . 30 ] & \\ {A}_{0} = [ r ( {T}_{1} ) , r ( {T}_{2} ) , , r ( {T}_{N} ) ] ∈ {ℂ}^{M \times N} & ( 30 )\end{matrix}$$

$$\begin{matrix}[ Math . 31 ] & \\ s = {[ {s}_{1} , {s}_{2} , , {s}_{N} ]}^{T} ∈ {ℂ}^{N} & ( 31 )\end{matrix}$$

T₁, T₂, . . . , T_{N} denote N delay times to be searched. T₁, T₂, . . . , T_{N} are also referred to as delay time bins. The delay time bin is an example of a set time. In addition, N>>L.

Here, A is also referred to as a delay time bin mode matrix. The delay time bin mode matrix is a matrix consisting of a plurality of elements representing the delay profile when it is assumed that a signal has been received at each of the plurality of delay time bins. For example, r(T₁), which is an element of the delay time bin mode matrix A, is a delay profile of the signal when it is assumed that the signal has been received at time T₁.

Moreover, s is also referred to as an extended signal vector. The extended signal vector is a vector consisting of a plurality of elements representing the presence or absence of a signal for each delay time bin and the amplitude and phase of the signal.

### (3) Estimation of Propagation Delay Time Based on Extended Signal Vectors

According to the sparse reconstruction, the delay profile z is modeled in the form of As+n. Therefore, it is possible to obtain the extended signal vector s by solving an inferior decision problem in which the unknown number is N and the number of conditions is M (M<N). The control unit 230 estimates the reception time of the first arrival wave on the basis of the delay time bins corresponding to the plurality of elements in the extended signal vector s.

Here, the non-zero element of the extended signal vector indicates that there is a signal in the delay time bin corresponding to the non-zero element. On the other hand, the zero element of the extended signal vector indicates that there is no signal in the delay time bin corresponding to the zero element. Therefore, the control unit 230 estimates a delay time bin corresponding to the non-zero element among the delay time bins corresponding to the plurality of elements in the extended signal vector s as the reception time of the first arrival wave.

In this case, the control unit 230 estimates the sparse solution of the extended signal vector s and estimates the delay time bin corresponding to the non-zero element of the estimated sparse solution as the reception time of the first arrival wave. A sparse solution is a vector in which only a predetermined number of elements are non-zero. The predetermined number is the number of pulses included in the reception signal as pulses corresponding to the pulses included in the transmission signal. That is, a sparse solution is a vector in which only L elements are ideally non-zero and the other elements are zero, when multipath waves that are L waves are received. For example, when s₂ is non-zero in s=[s₁, s₂, . . . , s_{N}], it is determined that the signal has been received at the delay time T₂. Although a situation in which an element that is originally zero becomes non-zero due to noise is considered, the control unit 230 may perform estimation under the assumption that there is a pulse corresponding to the element when a certain element is non-zero without considering noise. Even in this case, according to the estimation method to be described below, it is possible to eliminate the influence of noise and implement highly accurate estimation. On the other hand, the control unit 230 may determine whether or not the non-zero element is noise and may perform estimation for the element determined to be noise by considering the element as zero.

In particular, the control unit 230 estimates the shortest delay time bin among the delay time bins corresponding to the non-zero elements included in the extended signal vector s as the reception time of the first arrival wave. For example, when s₂, s₄, and s₆ are non-zero in s=[s₁, s₂, . . . , s_{N}], it is determined that a signal is received via the fast path at the delay time T₂ and signals are received via a path other than the fast path at the delay times T₄ and T₆.

The resolution of a signal obtained by a sparsely reconstructed model is determined by a magnitude of N (i.e., the number of elements of the extended signal vector s) at the time of modeling in the sparse reconstruction. Therefore, it is possible to separate multipath waves with a finer resolution than that of the CIR by increasing the number of N during sparse reconstruction. Therefore, in the present embodiment, the number of delay time bins N is increased beyond the number of samples M of the reception signal. In other words, in the present embodiment, the time interval of N delay time bins T₁, T₂, . . . , T_{N} is shorter than the time interval of M discrete delay times τ₁, τ₂, . . . , τ_{M}. With such a configuration, it is possible to separate multipath waves with a finer resolution than the sampling interval of the reception signal. As a result, it is possible to obtain the reception time of the first arrival wave with a finer resolution than that of the CIR.

### (3) Compressive Sensing Algorithm

The control unit 230 estimates an extended signal vector s that becomes a sparse solution using a compressive sensing algorithm. The compressive sensing algorithm is an algorithm that assumes that the unknown vector is a sparse vector and estimates an unknown vector on the basis of linear observation for the unknown vector. In the present embodiment, the extended signal vector s is an example of the unknown vector. The linear observation is a process of obtaining a result of multiplying the unknown vector by a coefficient. In the present embodiment, the bin mode matrix A is an example of a coefficient. The delay profile z is an example of the linear observation.

Compressive sensing algorithms include a focal underdetermined system solver (FOCUSS), an iterative shrinkage thresholding algorithm (ISTA), and a fast ISTA (FISTA) and the like. The control unit 230 may employ any of these compressive sensing algorithms. Hereinafter, an example in which the extended signal vector s is estimated using the FOCUSS will be described as an example. The FOCUSS is an algorithm that assumes an initial value for an unknown vector and iteratively estimates the unknown vector using a general inverse matrix and a weight matrix. By using the general inverse matrix and the weight matrix, the FOCUSS is enabled to estimate the unknown vector with high accuracy with a small number of iterations. The basic principles of the FOCUSS are described in detail in Non-Patent Literature “Irina F. Gorodnitsky, Member, IEEE, and Bhaskar D. Rao, “Sparse Signal Reconstruction from Limited Data Using FOCUSS: A Re-weighted Minimum Norm Algorithm,” IEEE TRANSACTIONS ON SIGNAL PROCESSING, VOL. 45, NO. 3, March 1997.”

The problem of estimating an extended signal vector s that is a sparse solution from the delay profile z is an inferior decision problem in which the number of unknowns is N and the number of conditions is M (M<N). Therefore, another condition is added to obtain the solution. Typically, a condition in which a norm for the extended signal vector s is minimized is added and a minimum norm solution is obtained. The norm is a length of the vector.

### —Determination of Initial Value so of FOCUSS.

In the above Eq. (29), when the internal noise n is ignored, if the delay profile z is multiplied by the inverse matrix of the delay time bin mode matrix A, the matrix A disappears (i.e., becomes an identity matrix), so that the extended signal vector s can be extracted. However, the inverse matrix of the delay time bin mode matrix A does not exist. Therefore, a minimum norm solution sₘₙ is obtained by multiplying the delay profile z by the general inverse matrix of the delay time bin mode matrix A as shown in the following equation. The general inverse matrix may be a general Moore-Penrose inverse matrix.

$$\begin{matrix}[ Math . 32 ] & \\ {s}_{mn} = {A}^{-} z = {{A}^{H} ( {AA}^{H} )}^{- 1} z & ( 32 )\end{matrix}$$

Here, A⁻ denotes a general inverse matrix of the delay time bin mode matrix A. The general inverse matrix A⁻ of the delay time bin mode matrix A is expressed by the following equation.

$$\begin{matrix}[ Math . 33 ] & \\ {A}^{-} = {{A}^{H} ( {AA}^{H} )}^{- 1} & ( 33 )\end{matrix}$$

Even if the delay time bin mode matrix A is multiplied by the general inverse matrix A⁻ of the delay time bin mode matrix A, the delay time bin mode matrix A is not completely lost, so that a vector similar to the extended signal vector s, which is a sparse solution, is calculated as the minimum norm solution sₘₙ. In addition, the minimum norm solution sₘₙ becomes an initial value so of the FOCUSS.

### —Application of FOCUSS

The minimum norm solution sₘₙ is not a sparse solution. Therefore, the control unit 230 estimates a weighted minimum norm solution that is a vector for minimizing the norm of a vector obtained by weighting the extended signal vector s as a process of estimating the sparse solution of the extended signal vector s. By estimating the weighted minimum norm solution, it is possible to estimate the sparse solution. The weighted minimum norm solution is expressed by the following equation.

$$\begin{matrix}[ Math . 34 ] & \\ s = {W ( AW )}^{-} z & ( 34 )\end{matrix}$$

Here, W denotes a weight matrix. The weight matrix W is typically a diagonal matrix. That is, the problem of finding the weighted minimum norm solution of the extended signal vector s is described as follows.

$$\begin{matrix}[ Math . 35 ] & \\ \begin{matrix}Find s = Wq \\ Where q = arg min ‖ q ‖ subject to AWq = z\end{matrix} & ( 35 )\end{matrix}$$

Specifically, the control unit 230 estimates the weighted minimum norm solution of the extended signal vector s by iteratively calculating Eq. (36), Eq. (37), and Eq. (38) shown in the following steps STEP1 to STEP3.

$$\begin{matrix}[ Math . 36 ] & \\ {W}_{k} = diag ( \vert {s}_{k - 1} ( 1 ) , , {s}_{k - 1} ( N ) \vert ) & ( 36 )\end{matrix}$$

$$\begin{matrix}[ Math . 37 ] & \\ {q}_{k} = {( {AW}_{k} )}^{-} z & ( 37 )\end{matrix}$$

$$\begin{matrix}[ Math . 38 ] & \\ {s}_{k} = {W}_{k} {q}_{k} & ( 38 )\end{matrix}$$

Here, k denotes the number of iterations. sₖ denotes a candidate for the weighted minimum norm solution. (AW_{K})⁻ denotes a general inverse matrix of AWₖ. As described above, an initial value of sₖ is given by the following equation as the minimum norm solution sₘₙ.

$$\begin{matrix}[ Math . 39 ] & \\ s {\vert}_{k = 0} = {s}_{mn} & ( 39 )\end{matrix}$$

The control unit 230 iteratively executes the above-described steps STEP1 to STEP3. As an example, the steps STEP1 to STEP3 may be iteratively executed until sₖ converges. As another example, the steps STEP1 to STEP3 may be iteratively executed a predetermined number of times. Thereby, it is possible to estimate the extended signal vector s as a weighted minimum norm solution that is closer to the true value. In this regard, description will be given below.

By the above Eq. (37), Eq. (38) is converted into the following equation.

$$\begin{matrix}[ Math . 40 ] & \\ {s}_{k} = {{W}_{k} ( {AW}_{k} )}^{-} z & ( 40 )\end{matrix}$$

If the noise n in Eq. (29) is ignored, Eq. (40) is converted into the following equation.

$$\begin{matrix}[ Math . 41 ] & \\ {s}_{k} = {{W}_{k} ( {AW}_{k} )}^{-} As & ( 41 )\end{matrix}$$

Here, if Wₖ(AWₖ)⁻A is a matrix that does not change s like an identity matrix, sₖ and s are equal. In the FOCUSS, it is possible to estimate the extended signal vector s as a weighted minimum norm solution that is closer to the true value by making Wₖ(AWₖ)⁻A close to a matrix that does not change s like an identity matrix while iteratively updating the weight matrix Wₖ.

### (4) Singular Value Decomposition

In estimating the extended signal vector s, the control unit 230 may obtain a general inverse matrix (AWₖ)⁻ of AWₖ by performing singular value decomposition. In this case, the control unit 230 may obtain (AWₖ)⁻ using truncated singular value decomposition (TSVD).

In this case, the control unit 230 calculates (AWₖ)⁻ after decomposing AWₖ into a format including a diagonal matrix consisting of singular values that are values greater than a predetermined threshold value according to singular value decomposition in Eq. (37) of the above-described STEP2. AWₖ is decomposed into singular values as follows.

$$\begin{matrix}[ Math . 42 ] & \\ {AW}_{k} = {U}_{t} {S}_{t} {V}_{t}^{H} & ( 42 )\end{matrix}$$

Here, Sₜ is a diagonal matrix consisting of t non-zero singular values. Uₜ is a matrix consisting of left singular vectors of sequence t corresponding to Sₜ. Vₜ is a matrix consisting of right singular vectors of sequence t corresponding to Sₜ. t denotes the number of dimensions of a signal subspace. The signal subspace is a space consisting of signals whose power is greater than the threshold value. In addition, Vₜ^{H} denotes a complex conjugate transpose of the matrix Vₜ and is also referred to as an adjoint matrix of Vₜ. In this case, (AWₖ)⁻ is obtained by the following equation.

$$[ Math . 43 ]$$

$${( {AW}_{k} )}^{-} = {V}_{t} {S}_{t}^{- 1} {U}_{t}^{H} \qquad ( 43 )$$

Here, Sₜ includes non-zero singular values equal in number to the number of dimensions t of the signal subspace. That is, Sₜ is a diagonal matrix consisting of t singular values having values greater than a predetermined threshold. Also, t is equal to the number of multipath waves L. Therefore, as described above, it is possible to reduce an influence of noise by obtaining a general inverse matrix using only singular values that belong to the signal subspace (i.e., that are large values). This is because a singular value that does not belong to the signal subspace (i.e., that is a small value) corresponds to noise. By reducing the influence of noise, it is possible to obtain a general inverse matrix stably and accurately even under the influence of noise.

### (5) Regularization

In the above, a case where the control unit 230 performs singular value decomposition to obtain (AWₖ)⁻ has been described. On the other hand, the control unit 230 may perform regularization using a regularized-FOCUSS (R-FOCUSS) or the like to obtain (AWₖ)⁻. At this time, the control unit 230 may use the following Eq. (44) instead of Eq. (37) of the above-described STEP2. In addition, Aₜ^{H} denotes a complex conjugate transpose of the matrix Aₖ, and is also referred to as an adjoint matrix of Aₖ.

$$[ Math . 44 ]$$

$${q}_{k} = {{A}_{k}^{H} ( {A}_{k} {A}_{k}^{H} )}^{- 1} Z \qquad ( 44 )$$

$$with$$

$${A}_{k} = {AW}_{k}$$

However, in the above Eq. (44), when AₖAₖ^{H} is not regular, the inverse matrix (AₖAₖ^{H})⁻¹ cannot be obtained. For this reason, the control unit 230 may use the following Eq. (45) instead of Eq. (44) in the above-described STEP2.

$$[ Math . 45 ]$$

$${q}_{k} = {{A}_{k}^{H} ( {A}_{k} {A}_{k}^{H} + α I )}^{- 1} Z \qquad ( 45 )$$

$$with$$

$${A}_{k} = {AW}_{k}$$

Here, a in Eq. (45) denotes a positive minute quantity. I denotes an identity matrix. α is also referred to as a regularization parameter. As shown in the above Eq. (45), by using the regularization parameter, even if AₖAₖ^{H} is not regular, it is possible to obtain the inverse matrix (AₖAₖ)⁻¹ of AₖAₖ^{H} by making AₖAₖ^{H}+αI regular. Moreover, by using regularization parameters, it is possible to implement the convergence of Sₖ more easily. In addition, the regularization parameters in the FOCUSS are mentioned in the above-described Non-Patent Literature.

In addition, the control unit 230 may use the TSVD to obtain the inverse matrix (AₖAₖ^{H})⁻¹ of AₖAₖ^{H}. In this case, in the above Eq. (44), the control unit 230 calculates (AₖAₖ^{H})⁻¹ after decomposing AₖAₖ^{H} into a format including a diagonal matrix consisting of singular values that are values greater than the first threshold according to the singular value decomposition process. The singular value decomposition process is performed on AₖAₖ^{H} as follows.

$$[ Math . 46 ]$$

$${A}_{k} {A}_{k}^{H} = {U}_{t} {S}_{t} {V}_{t}^{H} \qquad ( 46 )$$

At this time, (AₖAₖ^{H})⁻¹ is obtained by the following equation.

$$[ Math . 47 ]$$

$${( {A}_{k} {A}_{k}^{H} )}^{- 1} = {V}_{t} {S}_{t}^{- 1} {U}_{t}^{H} \qquad ( 47 )$$

Because AₘAₘ^{H} is a square matrix, the singular value decomposition here is also referred to as eigenvalue decomposition. Also, the TSVD is referred to as truncated eigen value decomposition (TEVD).

As described above, an example of calculation of (AWₖ)⁻ has been described with a specific example. In addition, when singular value decomposition is used in the calculation of (AWₖ)⁻, unnecessary singular values can be removed, and the calculation time may be shortened. On the other hand, when singular value decomposition is not used in the calculation of (AWₖ)⁻, the effect of improvement of estimation accuracy is expected when the singular value is not excluded.

### (6) Threshold Value Processing

In the FOCUSS, threshold value processing may be performed. The threshold value processing here is a process of setting elements of a predetermined threshold value or less to 0. For example, in Eq. (36) of the above-described STEP1, the control unit 230 may set elements of a predetermined threshold value or less among the elements included in the weight matrix Wₖ to 0. As an example, in the above-described STEP1, the threshold value processing shown in the following equation may be performed.

$$[ Math . 48 ]$$

$$STEP 1 \text{:} {w}_{k} ( i ) = \{ \begin{matrix}0 & \vert {s}_{k - 1} ( i ) \vert < {10}^{- 5} {\vert {s}_{k - 1} ( i ) \vert}_{max} \\ \vert {s}_{k - 1} ( i ) \vert & otherwise\end{matrix} \qquad ( 48 )$$

Here, wₖ (i) denotes an i^{th} diagonal component of the weight matrix Wₖ. sₖ₋₁(i) denotes an i^{th} component of the extended signal vector sₖ₋₁. |sₖ₋₁(i)|ₘₐₓ denotes a maximum magnitude value of the elements included in sₖ₋₁(i). 10⁻⁵|sₖ₋₁(i)/max denotes an example of a threshold value.

According to the above-described threshold value processing, when the weight matrix Wₖ is created, elements having values less than a threshold value among the elements of the extended signal vector s are considered to be noise instead of signals and are converted into zero. Thereby, it is possible to cause the extended signal vector s to converge more quickly. Moreover, because the number of non-zero elements is reduced, it is possible to easily obtain a sparse solution.

### (7) 2D-FOCUSS

An example for a case where the control unit 230 uses the FOCUSS as a compressive sensing algorithm for estimating the extended signal vector s that becomes a sparse solution has been described above.

According to the process using the FOCUSS as described above, the extended signal vector s can be estimated with high accuracy and therefore the accuracy of estimation of the distance between the devices can be improved.

However, because the FOCUSS is a process of performing multipath separation on the basis of time information (distance information), it may be difficult to perform multipath separation when a propagation delay time (sometimes simply referred to as delay time) difference between multipath waves is extremely small.

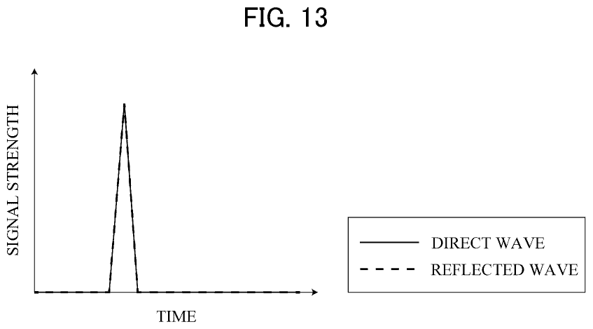

For example, in FIG. 13, a graph representing the signal strength of the reception signal along the time axis is shown. When the propagation delay time difference between the direct wave and the reflected wave is extremely small, signal strengths of the two waves overlap as shown in FIG. 13 and it is difficult to separate the two waves on the basis of time information.

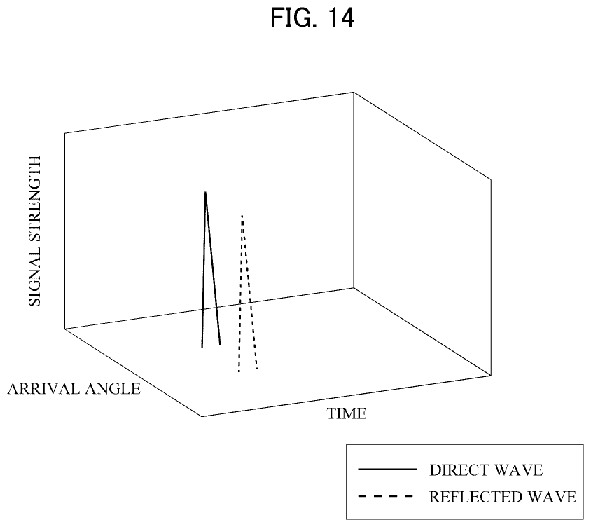

On the other hand, in FIG. 14, a graph in which the signal strength of the reception signal is expressed using a time axis and an arrival angle axis is shown. As shown in FIG. 14, even if the propagation delay time difference between the direct wave and the reflected wave is extremely small, it is possible to easily separate the two waves when the arrival angles of the two waves are different.

The technical idea according to the present embodiment is conceived by focusing on the above points and the accuracy of estimation of a distance and angle between devices is improved.

For this purpose, the control unit 230 may estimate the extended signal vector s using a 2D-FOCUSS instead of the FOCUSS described above. When the control unit 230 executes the 2D-FOCUSS, it is basically required that the communication unit 200 includes a plurality of antennas 211. However, when the antenna 211 is movably provided, it is possible to perform signal processing as described below as if the signal has been received by the plurality of antennas 211 virtually by receiving a signal while moving a single antenna 211.

As described above, the FOCUSS is a type of compressive sensing algorithm for performing the estimation of the extended signal vector s using a delay time bin mode matrix including time information.

The delay time bin mode matrix A in the FOCUSS is expressed, for example, by the following Eq. (49).

$$[ Math . 49 ]$$

$$A = [ r ( {T}_{1} ) , ⋯ , r ( {T}_{N} ) ] \qquad ( 49 )$$

On the other hand, the 2D-FOCUSS is a type of compressive sensing algorithm for performing the estimation of the extended signal vector s using a bin mode matrix containing time information and angle information.

The bin mode matrix A in the 2D-FOCUSS is expressed, for example, by the following Eq. (50).

$$[ Math . 50 ]$$

$$A = [ a ( {T}_{1} , {θ}_{1} ) , ⋯ , a ( {T}_{N} , {θ}_{1} ) , a ( {T}_{1} , {θ}_{2} ) , ⋯ , a ( {T}_{N} , {θ}_{P} ) ] \qquad ( 50 )$$

$$a ( {T}_{n} , {θ}_{p} ) = a ( {θ}_{p} ) ⊗ r ( {T}_{n} )$$

In addition, N in the above Eq. (49) and Eq. (50) denotes the number of propagation delay time bins. P in the above Eq. (50) denotes the number of arrival angle bins. a(Tₙ, θₚ) in the above Eq. (50) denotes a mode vector. a(θₚ) is a vector (also referred to as a direction mode vector) indicating a reception signal phase relationship between the antennas 211 when a signal from the arrival direction θₚ is received by the plurality of antennas 211. r(Tₙ) is a vector (also referred to as a time mode vector) consisting of an autocorrelation function of a transmission signal having a peak at time Tₙ.

Hereinafter, the estimation of the extended signal vector s using the 2D-FOCUSS by the control unit 230 will be described in detail.

In addition, a process of an iterative arithmetic operation or the like in the 2D-FOCUSS is basically the same as that in the FOCUSS. For example, in the 2D-FOCUSS, as in the FOCUSS, the weighted minimum norm solution of the extended signal vector s is estimated by iteratively calculating the above Eqs. (36) to (38). On the other hand, in the 2D-FOCUSS and the FOCUSS, the input delay profile and bin mode matrix and the output (estimated) extended signal vector are different from each other.

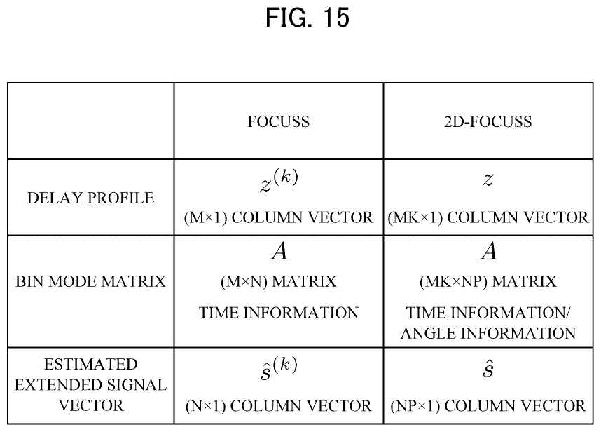

FIG. 15 is a diagram schematically showing the differences between the delay profile, the bin mode matrix, and the estimated extended signal vector in the 2D-FOCUSS and the FOCUSS.

As shown in FIG. 15, the delay profile z^{(k)} in the FOCUSS is an (M×1) column vector, whereas the delay profile z in the 2D-FOCUSS is an (MK×1) column vector.

In addition, M denotes the number of delay time samples and K denotes the number of antennas 211 (hereinafter also referred to as elements) provided in the communication unit 200. Moreover, k denotes an element (a k^{th} element) of any number among the plurality of elements.

Moreover, as shown in FIG. 15, the delay time bin mode matrix A in the FOCUSS is an (M×N) matrix including time information, whereas the bin mode matrix A in the 2D-FOCUSS is an (MK×NP) matrix including time information and angle information.

In addition, N denotes the number of propagation delay time bins and P denotes the number of arrival angle bins.

Moreover, as shown in FIG. 15, the extended signal vector s^{(k)} estimated in the FOCUSS is an (N×1) column vector, while the extended signal vector s estimated in the 2D-FOCUSS is an (NP×1) column vector.

Hereinafter, differences between delay profiles, bin mode matrices, and extended signal vectors in the 2D-FOCUSS and the FOCUSS will be described in detail.

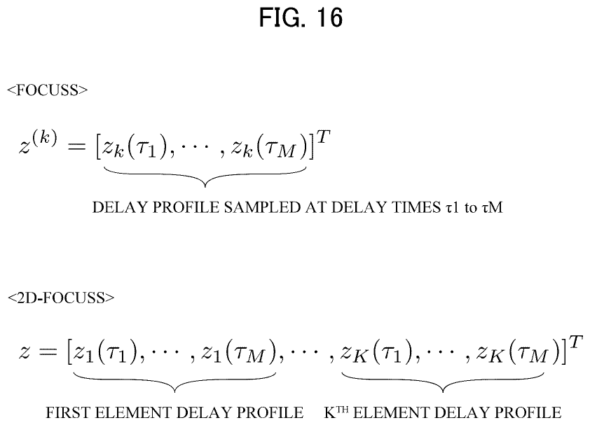

First, a delay profile difference between the 2D-FOCUSS and the FOCUSS will be described in detail with reference to FIG. 16.

As shown in the upper part of FIG. 16, the delay profile z^{(k)} in the FOCUSS includes M delay profiles sampled with delay times τ₁ to τ_{M} as elements. On the other hand, as shown in the lower part of FIG. 16, the delay profile z in the 2D-FOCUSS includes (M×K) delay profiles sampled with delay times τ₁ to τ_{M} related to the first to k^{th} elements, respectively.

Thus, the delay profile z in the 2D-FOCUSS, i.e., a correlation calculation result, may be a result of correlating the second signal and the first signal for each specified time and antenna 211.

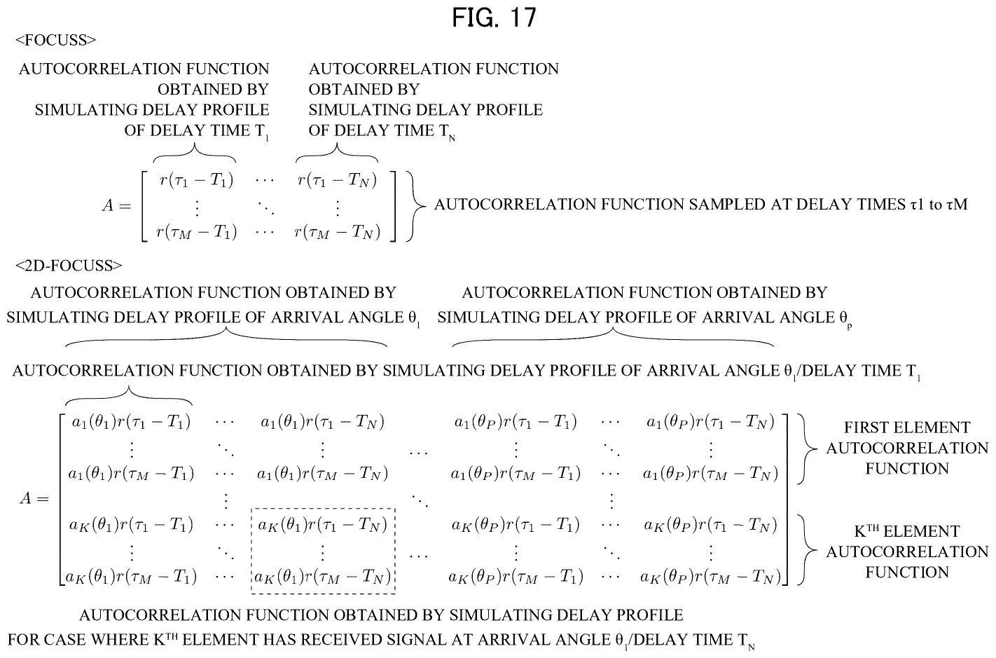

Next, a bin mode matrix difference between the 2D-FOCUSS and the FOCUSS will be described in detail with reference to FIG. 17.

As shown in the upper part of FIG. 17, the delay time bin mode matrix A in the FOCUSS includes (M×N) elements in which an autocorrelation function sampled with delay times τᵢ to τ_{M} in the column direction and an autocorrelation function obtained by simulating the delay profile for a case where the signals have been received at the delay times T₁ to T_{N} in the row direction are defined. In addition, a delay profile measured in advance may be used instead of the autocorrelation function obtained by simulating the delay profile.

On the other hand, as shown in the lower part of FIG. 17, the bin mode matrix A in the 2D-FOCUSS includes (MK×NP) elements in which an autocorrelation function for each of K elements sampled with the delay times τ₁ to τ_{M} in the column direction and an autocorrelation function obtained by simulating a delay profile for a case where signals have been received at the arrival angles θ₁ to θ_{P} and the delay times T₁ to T_{N} in the row direction are defined.

Thus, the bin mode matrix A in the 2D-FOCUSS may be a matrix consisting of a plurality of elements indicating correlation calculation results when it is assumed that the plurality of antennas 211 have received signals at the plurality of setting times and setting angles.

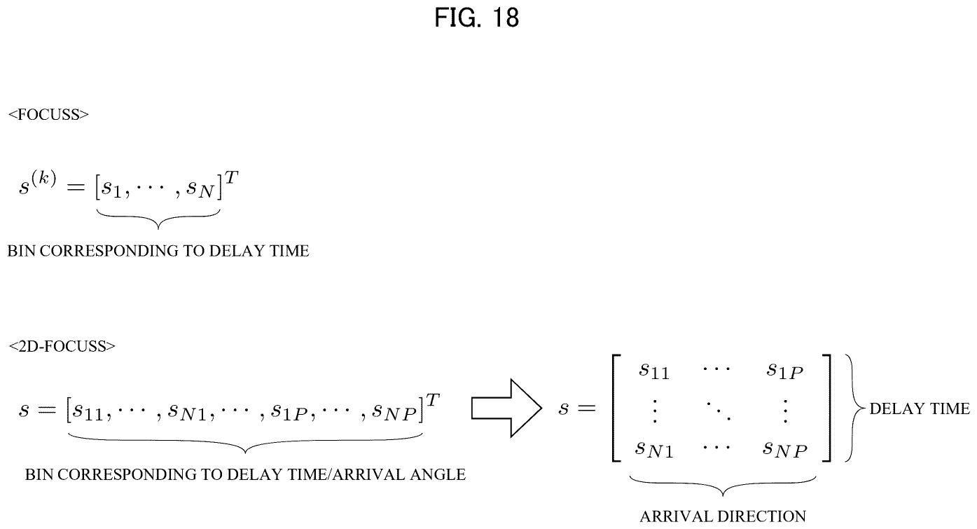

Next, the extended signal vector difference between the 2D-FOCUSS and the FOCUSS will be described in detail with reference to FIG. 18.

As shown in the upper part of FIG. 18, the extended signal vector s^{(k)} estimated in the FOCUSS includes N bins corresponding to the delay times T₁ to T_{N}.

In addition, as described above, in the extended signal vector s^{(k)} estimated in the FOCUSS, bins become zero except for bins in which there is a signal.

On the other hand, as shown on the lower left side of FIG. 18, the extended signal vector s estimated in the 2D-FOCUSS includes (N×P) bins corresponding to the delay times T₁ to T_{N} and the arrival angles θ₁ to θ_{P}.

In addition, sₙₚ denotes a complex amplitude signal having a delay time Tₙ and an arrival angle θₚ. Moreover, even in the extended signal vector s estimated in the 2D-FOCUSS, bins become zero except for the bins in which there is a signal.

From this, the control unit 230 may consider the time and angle corresponding to an element with a shortest delay time among non-zero elements (non-zero bins) in the extended signal vector s estimated using the 2D-FOCUSS as the signal reception time and arrival angle, respectively.

That is, the control unit 230 may estimate an earliest setting time among the setting times corresponding to the non-zero elements in the sparse solution of the estimated extended signal vector s as the reception time of the second signal and estimate a setting angle corresponding to the non-zero element corresponding to the earliest setting time as the arrival angle of the second signal.

On the other hand, the control unit 230 may estimate the reception time and the arrival angle of the second signal by designating the estimated extended signal vector s as a matrix based on the setting time and the setting angle and performing an amplitude peak search on the matrix.

On the lower right side of FIG. 18, an (N×P) matrix obtained by the control unit 230 converting the estimated extended signal matrix s on the basis of the delay time and arrival angle in shown. The control unit 230 may perform an amplitude peak search on the matrix and estimate the delay time and arrival angle corresponding to the element in which the peak is detected as the signal reception time and arrival angle, respectively.

When there are a plurality of peaks with the shortest delay time, the control unit 230 may estimate the delay time and arrival angle corresponding to the element in which the peak having the largest amplitude is detected as the signal reception time and arrival angle, respectively.

According to the peak search as described above, the estimation accuracy is expected to be improved compared to when the time and angle corresponding to the element with the shortest delay time are estimated as the signal reception time and arrival angle, respectively.

Differences between delay profiles, bin mode matrices, and estimated extended signal vectors in the 2D-FOCUSS and the FOCUSS have been described above in detail.

Subsequently, a specific example of the mode vector of the direction will be described.

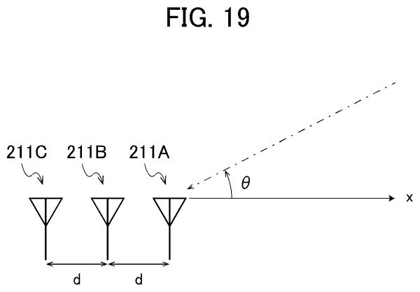

For example, as shown in FIG. 19, when the three antennas 211A to 211C are arranged at equal intervals d, the mode vector in the direction related to the signal indicated by a dash-dotted line is expressed as the following Eq. (51).

$$[ Math . 51 ]$$

$$a ( {θ}_{p} ) = {[ 1 , exp ( - j \frac{2 π d}{λ} cos {θ}_{p} ) , ⋯ , exp ( - j \frac{2 π d}{λ} ( K - 1 ) cos {θ}_{p} ) ]}^{T} \qquad ( 51 )$$

In the above Eq. (51), d denotes an element interval and λ denotes a wavelength. Moreover, each element of the mode vector in the direction indicated by the above Eq. (51) indicates a phase difference from a reference element (e.g., the antenna 211A (a first element)).

However, the arrival angle of the signal estimated using the 2D-FOCUSS is not limited to a one-dimensional angle (θ).

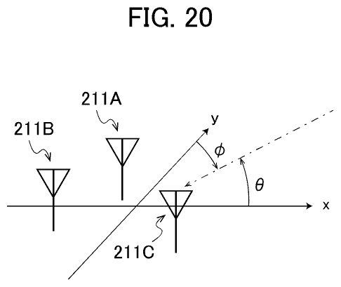

For example, as shown in FIG. 20, when three or more antennas 211 are arranged on a plane where the arrival angle of the signal is a two-dimensional angle (θ, q), the bin mode matrix A in the 2D-FOCUSS may be changed as shown in the following Eq. (52). In this case, each bin mode matrix A is an (ML×NPU) matrix.

$$[ Math . 52 ]$$

$$A = [ a ( {T}_{1} , {θ}_{1} , {φ}_{1} ) , ⋯ , a ( {T}_{N} , {θ}_{1} , {φ}_{1} ) , a ( {T}_{1} , {θ}_{2} , {φ}_{1} ) , ⋯ , a ( {T}_{N} , {θ}_{P} , {φ}_{1} ) , a ( {T}_{1} , {θ}_{1} , {φ}_{2} ) ⋯ , a ( {T}_{N} , {θ}_{P} , {φ}_{U} ) ] \qquad ( 52 )$$

$$a ( {T}_{n} , {θ}_{p} , {φ}_{u} ) = a ( {θ}_{p} , {φ}_{u} ) ⊗ r ( {T}_{n} )$$

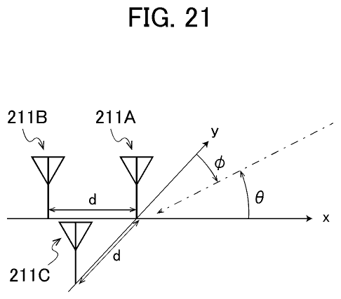

Moreover, for example, as shown in FIG. 21, when the three antennas 211A to 211C are arranged in an L-shape at equal intervals d, the mode vector of the direction is expressed as the following Eq. (53).

$$[ Math . 53 ]$$

$$a ( {θ}_{p} , {φ}_{u} ) = a ( {φ}_{u} ) ⊗ a ( {θ}_{p} ) \qquad ( 53 )$$

$$a ( {θ}_{p} ) = {[ 1 , exp ( - j \frac{2 π d}{λ} cos {θ}_{p} ) , 1 ]}^{T}$$

$$a ( {φ}_{u} ) = {[ 1 , 1 , exp ( - j \frac{2 π d}{λ} cos {φ}_{u} ) ]}^{T}$$

As described above, the mode vector and the bin mode matrix of the direction according to the present embodiment can be flexibly deformed in accordance with the arrangement of the elements.

Moreover, the arrival angle of the signal estimated using the 2D-FOCUSS may be a three-dimensional angle.

### 4.2. Estimation of Location Parameter

The control unit 230 estimates a location parameter on the basis of a first arrival wave detected by the above-described process.

### —Distance Measurement Process

The control unit 230 estimates a distance R between the portable device 100 and the communication unit 200 on the basis of a reception time of the first arrival wave estimated by the above-described process. A method for estimating the distance R is as described above with reference to FIG. 7.

However, the portable device 100 calculates a CIR with respect to the second distance measurement signal and executes sparse reconstruction and the FOCUSS. Also, the portable device 100 measures the time period INT₁ on the basis of the reception time of the first arrival wave of the estimated second distance measurement signal.

On the other hand, the communication unit 200 calculates a CIR with respect to the first distance measurement signal, performs sparse reconstruction, and executes the 2D-FOCUSS. Also, the communication unit 200 measures the time period INT₃ on the basis of the reception time of the first arrival wave of the estimated first distance measurement signal. Likewise, the communication unit 200 calculates a CIR with respect to the third distance measurement signal and executes the sparse reconstruction and the 2D-FOCUSS. Also, the communication unit 200 measures the time period INT₄ on the basis of the reception time of the first arrival wave of the estimated third distance measurement signal.

Also, the control unit 230 estimates the propagation delay time on the basis of the times T₁ to T₄ and estimates the distance R. As described above, because the reception time of the first arrival wave can be searched with a finer resolution than that of the CIR, it is possible to improve the accuracy of distance measurement accordingly.

### —Arrival Angle Estimation Process

As described above, the communication unit 200 can estimate the arrival angle of the first arrival wave by executing the 2D-FOCUSS.

### 4.3. Flow of Process

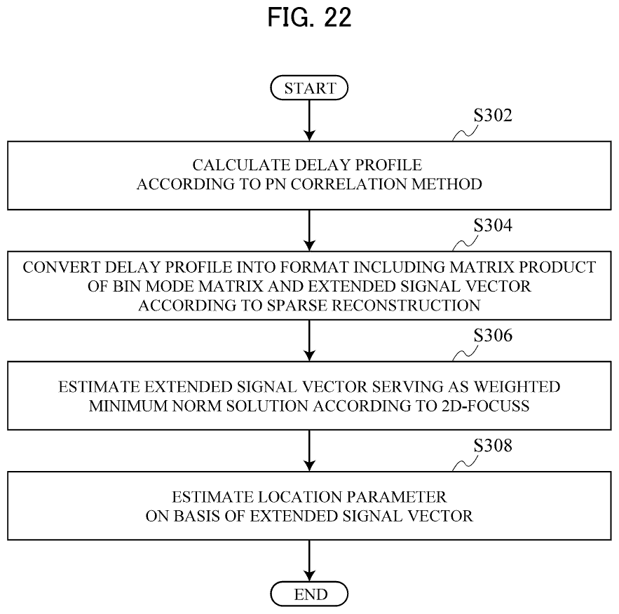

FIG. 22 is a flowchart showing an example of a flow of a location parameter estimation process executed by the communication unit 200 according to the present embodiment.

As shown in FIG. 22, first, the control unit 230 calculates a delay profile by a PN correlation method (step S302). Subsequently, the control unit 230 converts the delay profile into a format including a matrix product of a bin mode matrix and an extended signal vector by sparse reconstruction (step S304). Subsequently, the control unit 230 estimates an extended signal vector that becomes a weighted minimum norm solution according to the 2D-FOCUSS (step S306). Also, the control unit 230 estimates a location parameter on the basis of the estimated extended signal vector (step S308).

### 4.4. Regarding Application of 2D-FOCUSS

As described above, the transmission side may transmit a signal including a plurality of preambles, each of which includes one or more preamble symbols, as a transmission signal. In this case, the reception side may calculate a CIR for each preamble symbol by correlating each of parts corresponding to a plurality of preamble symbols in the reception signal and the preamble symbol at each specified time.

The 2D-FOCUSS may be applied to an integrated CIR obtained by integrating CIRs for preamble symbols. That is, the control unit 230 may convert the CIR into a format including a matrix product of the bin mode matrix and the extended signal vector and convert the integrated CIR obtained by integrating the CIRs for preamble symbols into a format including a matrix product of the bin mode matrix and the extended signal vector. Also, the sparse solution of the extended signal vector s is estimated by the 2D-FOCUSS and the reception time of the first arrival wave is estimated.

On the other hand, the 2D-FOCUSS may be applied to the CIR for each preamble symbol. In that case, a final extended signal vector s may be estimated by integrating the estimated extended signal vectors s for preamble symbols. That is, the control unit 230 may estimate the reception time and arrival angle of the first arrival wave on the basis of an integrated extended signal vector s that is a result of integrating the extended signal vectors s for the CIRs for the plurality of preambles as a process of estimating the reception time and arrival angle of the first arrival wave on the basis of the extended signal vector s.

The CIR may be calculated for each pulse. In this case, the 2D-FOCUSS may be applied to the integrated CIR obtained by integrating pulse-specific CIRs or may be applied to a pulse-specific CIR.

Moreover, a CIR may also be calculated for all preambles. In this case, the 2D-FOCUSS may be applied to the CIRs calculated for all preambles.

In any method, it is possible to obtain similar results.

### 4.5. Application Range of 2D-FOCUSS

The 2D-FOCUSS may be applied to all CIRs.

On the other hand, the FOCUSS may be applied to some CIRs. In details, the 2D-FOCUSS may be applied to a target of a vector consisting of elements corresponding to some set times and set angle among elements for set times and sett angles included in the extended signal vector s (hereinafter also referred to as a partial vector). In this case, the control unit 230 estimates a sparse solution of the partial vector as a process of estimating the sparse solution of the extended signal vector s. That is, the control unit 230 estimates a weighted minimum norm solution, which is a vector that minimizes the norm of the vector with a weight attached to the partial vector. Thereby, it is possible to reduce the calculation load compared to when the 2D-FOCUSS is applied to all CIRs.

In particular, if the purpose is to detect the first arrival wave, it is desirable to apply the 2D-FOCUSS only to some CIRs near the reception time and arrival angle of the first arrival wave. In this case, the 2D-FOCUSS is applied to a target of a partial vector including elements corresponding to a set time near the reception time and a set angle near the arrival angle in the first arrival wave among the elements for set times and setting angles included in the extended signal vector s. When the CIR is calculated on the basis of the preamble symbol, a strong correlation is obtained only at the delay time and arrival angle at which the pulse sequence of the transmission signal is completely consistent with the pulse sequence of the reception signal and the correlation is low in other parts. Therefore, even if the 2D-FOCUSS is applied only to some CIRs near the reception time and arrival angle of the first arrival wave, the detection accuracy of the first arrival wave can be maintained.

### 4.6. Beam Space Processing

Next, beam space processing according to the present embodiment will be described.

As described above, in the 2D-FOCUSS, two-dimensional estimation of distances and angles is performed. The calculation time in estimation of two dimensions or more like the 2D-FOCUSS increases compared to one-dimensional estimation.

Therefore, the control unit 230 according to the present embodiment can reduce the calculation time by performing beam space (also referred to as subspace) processing as a pre-processing of an estimation algorithm like the 2D-FOCUSS.

The above-described beam space processing is a process of forming a beam in the direction of arrival of the signal and is referred to as a process of obtaining a signal in which a main beam direction is emphasized by applying a space filter having different strength according to a signal arrival direction.

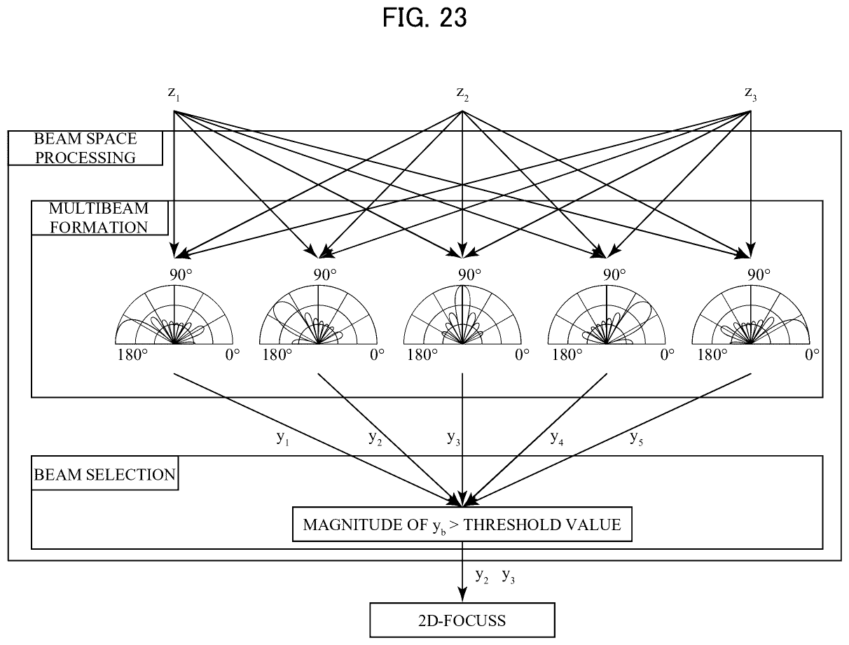

FIG. 23 is an explanatory diagram of an overview of beam space processing according to the present embodiment.

The control unit 230 according to the present embodiment performs beam space processing on delay profiles z₁ to z_{K} obtained from K elements and selected signal y₁ to y_{B} may be used as inputs of the 2D-FOCUSS.

In the case of the example shown in FIG. 23, the control unit 230 performs multibeam formation for the delay profiles z₁ to z₃ and designates signals y₂ and y₃ having a magnitude exceeding the threshold value among the signals y₁ to y₅ obtained as inputs of the 2D-FOCUSS.

According to the above-described process, the number of inputs to the estimation algorithm can be reduced compared to when beam space processing is not performed, and the calculation time of the estimation algorithm can be significantly reduced.

Hereinafter, the beam space processing according to the present embodiment will be described in more detail.

First, multibeam formation in beam space processing will be described.

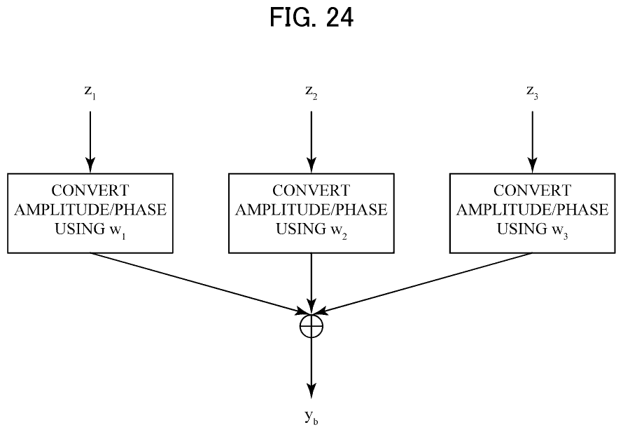

FIG. 24 is an explanatory diagram of multibeam formation according to the present embodiment.

For example, as shown in FIG. 24, the control unit 230 according to the present embodiment may perform multibeam formation using any weights w₁ to w₃ for the delay profiles z₁ to z₃.

The control unit 230 can flexibly set the direction of the beam by adjusting the phases of the weights w₁ to w₃ and flexibly set the shape (beam pattern) of the beam by adjusting the amplitudes of the weights w₁ to w₃.

Multibeam formation techniques can be broadly classified into a fixed pattern type and an adaptive type.

The fixed pattern type is a method for forming a plurality of beams oriented in any direction as shown in FIG. 23 by giving the amplitude and phase of the weight w in advance.

When fixed pattern type multibeam formation is performed, the control unit 230 may apply any of a uniform distribution, a binomial distribution, a Chebyshev distribution, and a Taylor distribution to the amplitude of the weight w.

For example, when a binomial distribution is applied, although the signal separation performance is reduced due to the thickening of the main lobe, it is possible to filter the side lobe to completely zero and it is possible to obtain the advantage of noise resistance.

On the other hand, the adaptive type is a technique for deciding the phase and amplitude of the weight w on the basis of the delay profiles z₁ to z_{K}.

When the adaptive type is used, it is theoretically possible to form an appropriate beam pattern in an appropriate direction in accordance with a radio wave environment. For this reason, the adaptive type has the advantage that the beam is directed in the signal arrival direction while noise and interference waves are eliminated and the beam is directed in the direction of the arrival of the true signal if the beam can be formed accurately.

Examples of the adaptive type include an eigenvector beam space method in which the eigenvector obtained by the eigenvalue decomposition of the delay profiles z₁ to z_{K} is the weight w and a method using a directionally constrained minimization of power (DCMP) adaptive array.

As described above, a multibeam forming method according to the present embodiment has been described with reference to specific examples.

The control unit 230 can also perform dynamic multibeam formation, such as using a fixed pattern type or an adaptive type in accordance with a radio wave environment or the like.

Subsequently, beam selection according to the present embodiment will be described in detail.

As shown in FIG. 23, the control unit 230 according to the present embodiment may select a signal whose magnitude (e.g., the norm when y_{b} is a vector) exceeds the threshold value among the signals y_{b} that have passed through the formed beam.

Alternatively, the control unit 230 may select N signals y_{b} in order from the largest value.

Moreover, when the eigenvector beam space method is used for multibeam formation, the control unit 230 may replace a magnitude of the signal y_{b} with an eigenvalue obtained by eigenvalue decomposition.

It is only necessary to appropriately design the number of signals y_{b} selected in accordance with the number of elements.

Moreover, the control unit 230 according to the present embodiment can further reduce the calculation time by selecting the signal y_{b} on the basis of the time domain as well as the angle domain.

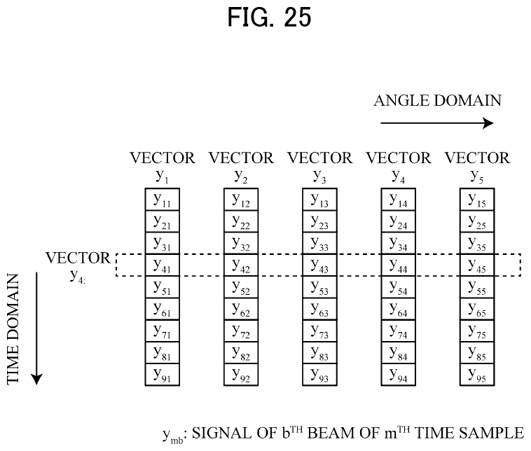

FIG. 25 is an explanatory diagram of a matrix of signals after multibeam formation according to the present embodiment.

In FIG. 25, the column vector is a signal vector of a b^{th} beam and the row vector is a signal vector of an M^{th} time sample.

Examples of beam selection include a method for performing selection based on the angle domain after selection based on the time domain, a method for performing selection based on the time domain after selection based on the angle domain, and a method for simultaneously performing selection based on the time domain and selection based on the angle domain.

First, a method for performing selection based on the angle domain after selection based on the time domain will be described. A configuration in which the selection of the angle domain is performed after the selection of the time domain is more preferred in systems with a high resolution of the time domain. Specifically, when the resolution of the time domain is high, because there is a high possibility that the noise in the time domain and the true signal can be separated, the noise can be accurately removed by selecting the time domain first. That is, because data is processed in a state in which noise has already been removed in the subsequent selection of the angle domain, the selection of the angle domain can be performed with higher accuracy.

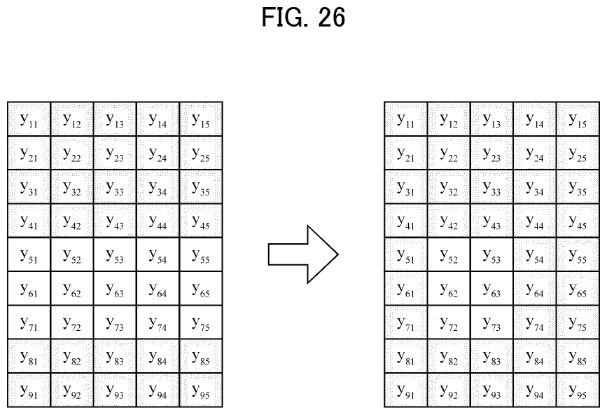

FIG. 26 is an explanatory diagram of a method for performing selection based on the angle domain after selection based on the time domain according to the present embodiment.

In this case, the control unit 230 first selects a row vector in which the norm of the row vector in the time domain exceeds the threshold value.

In FIGS. 26 to 28, selection targets are shown as a solid color and non-selection targets are shown as dots.

Here, when there are a plurality of clusters of row vectors exceeding the threshold value and the clusters are separated by a certain amount of time or more, the control unit 230 may discriminate each corresponding cluster as a separate arrival wave. Thus, when two or more waves are present, the control unit 230 may not select a signal with a time delay. Thereby, it is possible to eliminate unnecessary calculations.

Subsequently, the control unit 230 selects a column vector in which the norm for the column vector in the angle domain in the matrix composed only of the selected row vector exceeds a threshold value.

In addition, the control unit 230 may perform selection using threshold values different from each other in the time domain and the angle domain.

Next, a method for performing selection based on the time domain after selection based on the angle domain will be described. A configuration in which the selection of the time domain is performed after the selection of the angle domain is more preferred in systems with a high resolution of the angle domain. Specifically, when the resolution of the angle domain is high, because there is a high possibility that the noise in the angle domain and the true signal can be separated, the noise can be accurately eliminated by selecting the angle domain first. That is, because data of a state in which the noise has already been removed in the subsequent selection of the time domain is processed, the selection of the time domain can be performed with higher accuracy.

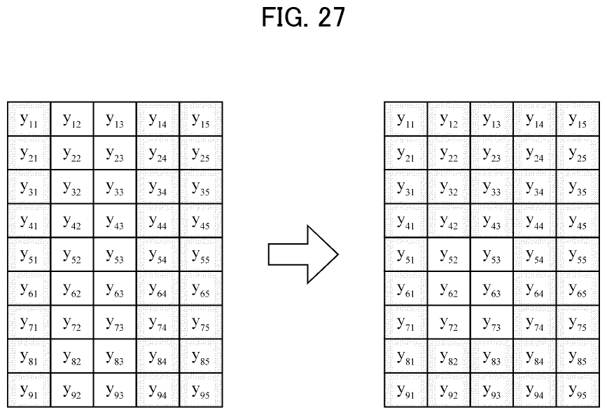

FIG. 27 is an explanatory diagram of a method for performing selection based on the time domain after selection based on the angle domain according to the present embodiment.

In this case, the control unit 230 first selects a column vector in which the norm of the column vector in the angle domain exceeds the threshold value.

Here, when an angle that does not need to be estimated in advance can be specified, the control unit 230 may not select a column vector in the predefined angle domain. Thereby, it is possible to eliminate unnecessary calculations. Such control is particularly useful when location information of the shield around the communication unit is known.

Next, the control unit 230 selects a row vector in which the norm of the row vector in the time domain exceeds the threshold value in the matrix composed only of the selected column vector.

In addition, the control unit 230 may perform selection using threshold values different from each other in the time domain and the angle domain.

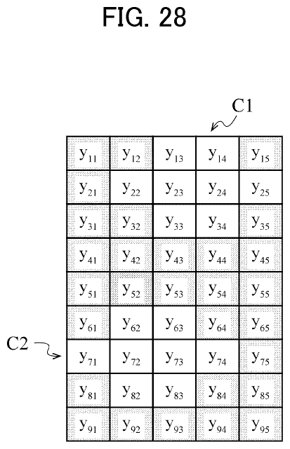

Next, a method for simultaneously performing selection based on the time domain and selection based on the angle domain according to the present embodiment will be described with reference to FIG. 28.

When the method is employed, it is only necessary for the control unit 230 to select an element in which the magnitude of each element of the signal matrix exceeds a threshold value.

Alternatively, the control unit 230 may select N elements in order of a magnitude instead of using a threshold value.

Moreover, when the method is employed, the control unit 230 can select a range that is not rectangular in a time-space domain as shown in FIG. 28, unlike the two methods described above. Thereby, it is possible to select elements with a higher degree of freedom compared to the case of sequential selection of time or angle.

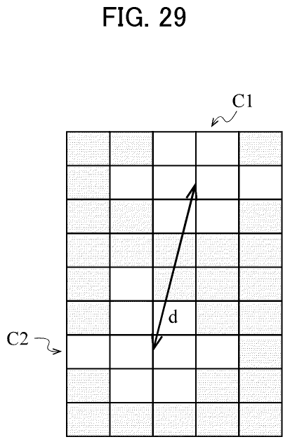

Moreover, even when selection based on the time domain and selection based on the angle domain are performed simultaneously, two or more arrival waves can be detected on the basis of the two-dimensional distance in the time-angle domain between the clusters. For example, as shown in FIG. 29, when the two-dimensional distance d between a cluster C1 and a cluster C2 exceeds the threshold value, the control unit 230 may discriminate the cluster C1 and the cluster C2 as separate arrival waves. Moreover, when two or more waves are present, the control unit 230 may not select a signal with a time delay. Thereby, it is possible to eliminate unnecessary calculations.

As described above, beam space processing according to the present embodiment has been described. According to the beam space processing according to the present embodiment, it is possible to significantly reduce the calculation time by limiting the information input to the estimation algorithm.

Here, more detailed signal conversion for the case where the 2D-FOCUSS is employed as the estimation algorithm will be described.

When beam space processing is not performed, the inputs for the 2D-FOCUSS are a delay profile z and a bin mode matrix A as described above.

On the other hand, when beam space processing is performed, the inputs for the 2D-FOCUSS are the delay profile z_{b} and the bin mode matrix B.

Specifically, the control unit 230 obtains the delay profile z_{b} and the bin mode matrix B by performing multibeam formation according to signal conversion as shown in the following Eqs. (55) using the weight (matrix) defined in the following Eqs. (54) and subsequently performing signal selection as shown in the following Eq. (56). In addition, F in the following Eqs. (54) to (56) denotes the number of beams generated in multibeam formation.

$$[ Math . 54 ]$$

$$W = [ {w}_{1} , ⋯ , {w}_{F} ] ∈ {ℂ}^{K \times F} \qquad ( 54 )$$

$${w}_{l} = {[ {w}_{1} , ⋯ , {w}_{K} ]}^{T} ∈ {ℂ}^{K \times 1}$$

$$[ Math . 55 ]$$

$${Z}_{F} = {( {W}_{F}^{H} {Z}^{T} )}^{T} ∈ {ℂ}^{M \times F} \qquad ( 55 )$$

$${B}_{F} = [ b ( {T}_{1} , {θ}_{1} ) , ⋯ , b ( {T}_{N} , {θ}_{1} ) , b ( {T}_{1} , {θ}_{2} ) , ⋯ , b ( {T}_{N} , {θ}_{P} ) ] ∈ {ℂ}^{MF \times NP}$$

$$b ( {T}_{n} , {θ}_{p} ) = b ( {θ}_{p} ) ⊗ r ( {T}_{n} )$$

$$b ( {θ}_{l} ) = {W}^{H} a ( {θ}_{l} ) ∈ {ℂ}^{F \times 1}$$

$$[ Math . 56 ]$$

$${z}_{F} = vec ( {Z}_{F} ) \qquad ( 56 )$$

$${z}_{F} ∈ {ℂ}^{MF \times 1} \to {z}_{b} ∈ {ℂ}^{CB \times 1}$$

$${B}_{F} ∈ {ℂ}^{MF \times NP} \to B ∈ {ℂ}^{CB \times NP}$$

The control unit 230 inputs the delay profile z_{b} and the bin mode matrix B obtained as described above to the 2D-FOCUSS and estimates the extended signal vector s.

Also, the bin mode matrix B and the extended signal vector s have a bin containing elements N corresponding to the delay times T₁ to T_{N} and elements P corresponding to the arrival angles θ₁ to θ_{P}, as described with reference to FIGS. 17 and 18.

The control unit 230 may determine the bin setting range in the bin mode matrix B and the extended signal vector s on the basis of the result of the beam space processing.

More specifically, the control unit 230 may determine the setting range of the bin described above on the basis of the time and angle range selected in the beam space processing. According to this, it is possible to further reduce the number of bins (N and P) and thus further reduce the amount of calculation.

Moreover, the beam space processing according to the present embodiment can be applied to various types of N-dimensional estimation algorithms (N≥2) for simultaneously estimating two or more parameters as well as the 2D-FOCUSS.

Examples of the above-described parameters include a distance, speed, acceleration, dielectric constant, and the like.

Furthermore, the inputs for the N-dimensional estimation algorithm are not limited to UWB signals, but can be waves in general such as radio waves, ultrasonic waves, and light.

Moreover, the inputs for the N-dimensional estimation algorithm may be a reflected wave in a radar or the like.

### 4.7. Modified Examples

In the above-described embodiment, an example in which the norm is the so-called 10 norm has been described. The 10 norm refers to the case where the exponent p in the lp norm is 0. The lp norm is defined by the following equation.

$$[ Math . 57 ]$$

$${‖ x ‖}_{p} = {\vert {x}_{1} \vert}^{p} + {\vert {x}_{2} \vert}^{p} + ⋯ + {\vert {x}_{n} \vert}^{p} \qquad ( 57 )$$

On the other hand, the 10 norm is defined by the following equation in which p=0 in the above Eq. (57).

$$[ Math . 58 ]$$

$${‖ x ‖}_{0} = {\vert {x}_{1} \vert}^{0} + {\vert {x}_{2} \vert}^{0} + ⋯ + {\vert {x}_{n} \vert}^{0} \qquad ( 58 )$$

However, in Eq. (58), it is assumed that 0⁰=0.

That is, the 10 norm is the number of non-zero components of the vector.

The method for iteratively executing Eqs. (36) to (38) cited in the above embodiment was a method for minimizing the 10 norm as a weighted minimum norm solution of the extended vector s. On the other hand, the control unit 230 may minimize the lp norm as a weighted minimum norm solution of the extended vector s. Specifically, the control unit 230 may use the following equation instead of STEP1.

$$[ Math . 59 ]$$

$$STEP 1 \text{:} {W}_{k} = diag ( {\vert {s}_{k - 1} ( 1 ) \vert}^{1 - \frac{p}{2}} , ⋯ , {\vert {s}_{k - 1} ( NP ) \vert}^{1 - \frac{p}{2}} ) \qquad ( 59 )$$

Here, p is a constant between 0 and 1. When p is 0, the above Eq. (59) is the same as Eq. (36). That is, the control unit 230 may estimate the weighted minimum norm solution using p as 0 in the above Eq. (59).

Even when p takes a value other than 0, it is possible to accurately estimate the reception time of the first arrival wave as in the above-described embodiment.

### 5. Supplement

Heretofore, preferred embodiments of the present invention have been described in detail with reference to the appended drawings, but the present invention is not limited thereto. It is obvious that a person skilled in the art can arrive at various alterations and modifications within the scope of the technical ideas defined in the claims, and it should be naturally understood that such alterations and modifications are also encompassed by the technical scope of the present invention.

For example, the case where the control unit 230 calculates the CIR, detects the first arrival wave, and estimates the location parameters has been described in the above-described embodiment, the present invention is not limited to such examples. At least one of these processes may be performed by the wireless communication unit 210. For example, in each of the plurality of wireless communication units 210, the CIR may be calculated on the basis of the reception signal received by each wireless communication unit 210 and the first arrival wave may be detected. Moreover, the location parameters may be estimated, for example, by the wireless communication unit 210 functioning as a master.

For example, an example in which the angles α and β are calculated on the basis of the antenna array phase difference in an antenna pair has been described in the above-described embodiment, but the present invention is not limited to this example. As an example, the communication unit 200 may calculate the angles α and β by performing beamforming with a plurality of antennas 211. In this case, the communication unit 200 scans the main lobes of the plurality of antennas 211 in all directions, determines that the portable device 100 is located in the direction with the highest received power, and calculates the angles α and β on the basis of this direction.

For example, the local coordinate system has been described as a coordinate system having a coordinate axis parallel to the axis connecting the antenna pair as described with reference to FIG. 3 in the above embodiment, but the present invention is not limited to this example. For example, the local coordinate system may be a coordinate system having a coordinate axis that is not parallel to the axis connecting the antenna pair. Moreover, the origin is not limited to the center of the plurality of antennas 211. The local coordinate system according to the present embodiment may be arbitrarily set on the basis of the arrangement of the plurality of antennas 211 provided in the communication unit 200.

For example, in the above-described embodiment, an example in which the authenticated party is the portable device 100 and the authenticating party is the communication unit 200 has been described, but the present invention is not limited to this example. The roles of the portable device 100 and the communication unit 200 may be reversed. For example, the portable device 100 may identify a location parameter. Moreover, the roles of the portable device 100 and the communication unit 200 may be dynamically exchanged. Moreover, the location parameters may be identified and authenticated between the communication units 200.

For example, an example in which the present invention is applied to a smart entry system has been described in the above embodiments, but the present invention is not limited to this example. The present invention can be applied to any system that estimates and authenticates location parameters by transmitting and receiving signals. For example, the present invention can be applied to a pair including any two devices among portable devices, vehicles, smartphones, drones, homes, home appliances, and the like. In this case, one of the pair acts as an authenticating party and the other acts as an authenticated party. In addition, the pair may include two devices of the same type or may include devices of two different types. The present invention is also applicable for a wireless local area network (LAN) router to identify the location of a smartphone.

For example, a wireless communication standard using the UWB has been mentioned in the above embodiment, but the present invention is not limited to this example. For example, one using infrared rays may be used as a wireless communication standard.

In addition, the series of processes according to each apparatus described herein may be implemented using either software, hardware, or a combination of software and hardware. The program constituting the software, for example, is stored in advance on a recording medium (non-transitory media) provided inside or outside each device. Also, each program, for example, is loaded into a RAM when executed by a computer and executed by a processor such as a CPU. The above-described recording medium is, for example, a magnetic disk, an optical disk, a magneto-optical disk, a flash memory, or the like. Moreover, the computer program may be distributed via a network, for example, without using a recording medium.

Moreover, the processes described herein using a flowchart may not necessarily be executed in the order shown in the drawing. Some processing steps may be executed in parallel. Moreover, additional processing steps may be employed and some processing steps may be omitted.

### REFERENCE SIGNS LIST

1 system
100 portable device
110 wireless communication unit
111 antenna
120 storage unit
130 control unit
200 communication unit
202 vehicle
210 wireless communication unit
211 antenna
220 storage unit
230 control unit

1. A communication device comprising:
a wireless communication unit configured to wirelessly receive signals from another communication device; and
a control unit configured to
correlate a first signal and a second signal, which is a signal corresponding to the first signal, received by the wireless communication unit at each specified time when the other communication device has transmitted a signal including a pulse as the first signal,
convert a correlation calculation result that is a result of correlating the second signal and the first signal at each specified time into a format including a matrix product of a bin mode matrix that is a matrix including a plurality of elements indicating the correlation calculation result when it is assumed that a signal has been received at each of a plurality of set times and a plurality of set angles and an extended signal vector that is a vector including a plurality of elements indicating presence or absence of a signal at each of the set time and the set angle and an amplitude and a phase of the signal, and
estimate a reception time and an arrival angle of the second signal on the basis of the set times and the set angles corresponding to the plurality of elements in the extended signal vector,
wherein an interval between the set times is shorter than the specified time.

2. The communication device according to claim 1, wherein the correlation calculation result is a result of correlating the second signal and the first signal for each antenna provided in the wireless communication unit at the specified time.

3. The communication device according to claim 2, wherein the bin mode matrix is a matrix including a plurality of elements indicating the correlation calculation result when it is assumed that a plurality of antennas have received signals at the plurality of set times and the plurality of set angles.

4. The communication device according to claim 3, wherein the control unit estimates the set time and the set angle corresponding to a non-zero element among the plurality of elements in the extended signal vector as the reception time and the arrival angle of the second signal, respectively.

5-18. (canceled)

19. The communication device according to claim 1, wherein the control unit performs beam space processing on the correlation calculation results and converts a selected signal into the format including the matrix product.

20. The communication device according to claim 19, wherein the control unit performs multibeam formation by adjusting a phase and an amplitude of a weight in the beam space processing.

21. The communication device according to claim 20, wherein the control unit applies any of a uniform distribution, a binomial distribution, a Chebyshev distribution, and a Taylor distribution to the amplitude of the weight.

22. The communication device according to claim 20, wherein the control unit adjusts the phase and the amplitude of the weight on the basis of the correlation calculation results.

23. The communication device according to claim 22, wherein the control unit adjusts the phase and the amplitude of the weight on the basis of an eigenvector obtained by eigenvalue decomposition of the correlation calculation results.

24. The communication device according to claim 22, wherein the control unit adjusts the phase and the amplitude of the weight using a DCMP adaptive array.

25. The communication device according to claim 19, wherein the control unit selects a signal whose magnitude exceeds a threshold value among signals that have passed through a formed beam in the beam space processing.

26. The communication device according to claim 25, wherein the control unit further selects a signal whose magnitude exceeds a threshold value in an angle domain after a signal whose magnitude exceeds a threshold value in a time domain is selected.

27. The communication device according to claim 25, wherein the control unit further selects a signal whose magnitude exceeds a threshold value in a time domain after a signal whose magnitude exceeds a threshold value in an angle domain is selected.

28. The communication device according to claim 27, wherein the control unit does not select a signal in a predefined angle domain.

29. The communication device according to claim 25, wherein the control unit selects a signal whose magnitude exceeds a threshold value in a time domain and an angle domain.

30. The communication device according to claim 26, wherein the control unit does not select a signal related to a second or subsequent wave.

31. The communication device according to claim 25, wherein the control unit selects a signal using threshold values different in a time domain and an angle domain.

32. The communication device according to claim 19, wherein the control unit determines a set range of a bin in the bin mode matrix and the extended signal vector on the basis of a beam space processing result.

33. An information processing method comprising:
wirelessly receiving signals from another communication device;
correlating a first signal and a second signal, which is a signal corresponding to the first signal, received at each specified time when the other communication device has transmitted a signal including a pulse as the first signal;
converting a correlation calculation result that is a result of correlating the second signal and the first signal at each specified time into a format including a matrix product of a bin mode matrix that is a matrix including a plurality of elements indicating the correlation calculation result when it is assumed that a signal has been received at each of a plurality of set times and a plurality of set angles and an extended signal vector that is a vector including a plurality of elements indicating presence or absence of a signal at each of the set time and the set angle and an amplitude and a phase of the signal; and
estimating a reception time and an arrival angle of the second signal on the basis of the set times and the set angles corresponding to the plurality of elements in the extended signal vector,
wherein an interval between the set times is shorter than the specified time.

34. A non-transitory computer readable storage medium storing a program for causing a computer to function as:
a control unit configured to
correlate a first signal and a second signal, which is a signal corresponding to the first signal, received by a wireless communication unit wirelessly receiving signals from another communication device at each specified time when the other communication device has transmitted a signal including a pulse as the first signal;
convert a correlation calculation result that is a result of correlating the second signal and the first signal at each specified time into a format including a matrix product of a bin mode matrix that is a matrix including a plurality of elements indicating the correlation calculation result when it is assumed that a signal has been received at each of a plurality of set times and a plurality of set angles and an extended signal vector that is a vector including a plurality of elements indicating presence or absence of a signal at each of the set time and the set angle and an amplitude and a phase of the signal; and
estimate a reception time and an arrival angle of the second signal on the basis of the set times and the set angles corresponding to the plurality of elements in the extended signal vector,
wherein an interval between the set times is shorter than the specified time.
